(19) United States
(12) Patent Application Publication
(10) Pub. No.: US 2010/0240799 A1
(43) Pub. Date: Sep. 23, 2010

(54) ANTIMICROBIAL FILM-FORMING COMPOSITION, ANTIMICROBIAL FILM, AND METHOD OF VERIFYING THE PRESENCE OF AN ANTIMICROBIAL FILM

(75) Inventors: Gerald R.A. Hofmann, Oakdale, MN (US); Mitchell T. Johnson, Gig Harbor, WA (US); Caroline M. Ylitalo, Stillwater, MN (US); Duane D. Fansler, Dresser, WI (US); Narina Y. Stepanova, Inver Grove Heights, MN (US); Erin A. Meulners, West st. Paul, MN (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 12/663,925

(22) PCT Filed: Jun. 13, 2008
(86) PCT No.: PCT/US2008/066876

§ 371 Date: Jun. 3, 2010

Related U.S. Application Data
(60) Provisional application No. 60/943,804, filed on Jun. 13, 2007.

(51) Int. Cl. C09D 5/16; G01N 21/00

(52) U.S. Cl. 523/122; 436/164

(57) ABSTRACT

An antimicrobial film-forming composition, an antimicrobial film, and a method of verifying the presence of an antimicrobial film. The film-forming composition can include no greater than 10 weight percent of polyvinyl alcohol, from 0.05 to 15 weight percent of polyhexamethylene biguanide, from 0.001 to 10 weight percent of a quaternary ammonium compound, and water or a water-based solvent. The film-forming composition can form a water-soluble, biocidal antimicrobial film that includes no greater than 98 weight percent of polyvinyl alcohol, and from 1 to 15 weight percent of each of polyhexamethylene biguanide and the quaternary ammonium compound. The method can include applying a film-forming composition comprising an indicator dye to a surface, drying the film-forming composition to form an antimicrobial film, and triggering the antimicrobial film to trigger the indicator dye to verify the presence of the film.

### BACKGROUND

The present invention relates to antimicrobial film-forming compositions and antimicrobial films formed therefrom. In particular, the present invention relates to water-soluble antimicrobial films for use on surfaces to reduce the risk of contamination by microorganisms.

Contamination by microorganisms can have a dramatic impact on human life and health. During everyday routines, people continuously come into contact with a variety of surfaces that are contaminated with one or more types of microorganisms, some of which may be pathogens. Such surfaces may include countertops, tables, and food preparation surfaces in restaurants, splash guards and conveyor belts in food processing plants, public facilities, display applications, and a variety of surfaces in healthcare settings.

Contamination with pathogenic microorganisms in such locations may result in the spread of disease and infections to people, which correspondingly endangers human lives and increases health care costs.

To counter the spread of undesired microorganisms, frequently touched, potentially contaminated surfaces are typically cleaned and sanitized on a regular basis.

### SUMMARY

While frequent cleaning of surfaces provides an immediate reduction in concentration of microorganisms on given surfaces, the surfaces typically must be repeatedly cleaned and sanitized on a frequent basis to continue to prevent contamination by microorganisms. One reason for this is because many antimicrobial materials used for cleaning and sanitation become ineffective when the surface is dried. In addition, many articles used to wipe visible dirt from surfaces may recontaminate the wiped surface with microorganisms that will grow and cause a cross-contamination hazard. For example, tables and food preparation surfaces at restaurants are continuously wiped with a sponge or towel to remove excess consumables and garbage. The article used for wiping frequently harbors pathogenic microorganisms that are transferred to the wiped surface.

Some existing cleaning compositions may provide residual antimicrobial activity, but upon reapplication tend to leave a residue that accumulates until a harsh solvent or frictional force is used to completely remove the cleaning composition.

Furthermore, in some existing cleaning compositions that include a polymer, the antimicrobial agent may at least partially interact with the polymer (i.e., form non-covalent bonds (e.g., ionic bonds, hydrogen bonds, matrix interactions, etc.) or covalent bonds with the polymer) so as not to be sufficiently available to provide biocidal activity to microorganisms that come into contact with the surface onto which the cleaning composition is applied. In other words, the resulting antimicrobial film may not have a sufficient surface concentration of the antimicrobial agent to provide biocidal activity. To overcome an insufficient surface concentration of the antimicrobial agent, some existing compositions include an increased concentration of the antimicrobial agent. While increasing the concentration of the antimicrobial agent in the composition may produce adequate biocidal activity, it may do so by comprising the film-forming properties of the film-forming composition, such that the film-forming composition may include poorer rheological properties or may produce an aesthetically displeasing (i.e., haze, streaks) antimicrobial film.

The antimicrobial film-forming composition of the present disclosure produces an antimicrobial film that has the desired biocidal activity without compromising the aesthetics of the antimicrobial film. The antimicrobial film-forming composition of the present disclosure includes a polymer that allows the antimicrobial to remain in an active state until the film-forming composition is either washed away with water or a water-based solvent, or replenished. In addition, the amount of the antimicrobial agent and the polymer in the antimicrobial film-forming composition of the present disclosure is optimized to provide the desired biocidal rates without significant build-up (i.e., less than 5% weight gain) upon reapplication.

Some embodiments of the present invention provide a film-forming composition that can include a polyvinyl alcohol having a concentration of no greater than 10 weight percent of the film-forming composition, a polyhexamethylene biguanide having a concentration of from 0.05 weight percent of the film-forming composition to 15 weight percent of the film-forming composition, a quaternary ammonium compound having a concentration of from 0.001 weight percent of the film-forming composition to 10 weight percent of the film-forming composition, and water or a water-based solvent in which the polyvinyl alcohol, the polyhexamethylene biguanide, and the quaternary ammonium compound are dissolved. The film-forming composition can exhibit fast-acting biocidal activity, and can form a water-soluble antimicrobial film that exhibits residual biocidal activity.

In some embodiments of the present invention, an antimicrobial film is provided that can include a polyvinyl alcohol having a concentration of no greater than 98 weight percent of the antimicrobial film, a polyhexamethylene biguanide having a concentration of from 1 weight percent of the antimicrobial film to 15 weight percent of the antimicrobial film, and a quaternary ammonium compound having a concentration of from 1 weight percent of the antimicrobial film to 15 weight percent of the antimicrobial film. The antimicrobial film can be water-soluble and biocidal.

Some embodiments of the present invention provide a film-forming composition that can include a polyvinyl alcohol, a polyhexamethylene biguanide, a quaternary ammonium compound, and water or a water-based solvent in which the polyvinyl alcohol, the polyhexamethylene biguanide, and the quaternary ammonium compound are dissolved. The weight ratio of polyvinyl alcohol to polyhexamethylene biguanide in the film-forming composition can range from 5:1 to 50:1, the weight ratio of polyvinyl alcohol to quaternary ammonium compound in the film-forming composition can range from 5:1 to 50:1, and the weight percent of the polyvinyl alcohol in the film-forming composition can be no greater than 10%. The film-forming composition can exhibit fast-acting biocidal activity, and can form a water-soluble antimicrobial film that exhibits residual biocidal activity.

In some embodiments of the present invention, a method of verifying the presence of an antimicrobial film is provided. The method can include applying a film-forming composition to a surface, wherein the film-forming composition comprises an indicator dye that is adapted to change between a first state and a second state. The method can further include drying the film-forming composition to form a water-soluble biocidal antimicrobial film, the antimicrobial film exhibiting the first state of the indicator dye. The method can further include triggering the indicator dye to change to the second state, such that the antimicrobial film exhibits the second state of the indicator dye to verify the presence of the antimicrobial film on the surface.

Other features and aspects of the invention will become apparent by consideration of the detailed description and accompanying drawings.

### BRIEF DESCRIPTION OF THE DRAWINGS

FIGS. 1A-1D illustrate a method of verifying the presence of an antimicrobial film according to one embodiment of the present invention, as explained in Example 2.

FIGS. 2A and 2B illustrate the Attenuated Total Reflection, Fourier Transformed Infrared Spectroscopy (ATR-FTIR) spectra of a composition comprising polyhexamethylene biguanide and polyvinylpyrrolidone, and a composition comprising polyhexamethylene biguanide and polyvinyl alcohol, respectively, as described in Example 10.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the term “applied,” and variations thereof are used broadly and encompass both direct and indirect applications. It is to be understood that other embodiments may be utilized, and structural or logical changes may be made without departing from the scope of the present disclosure.

The present invention generally relates to an antimicrobial film-forming composition, the antimicrobial film formed therefrom, and a method of verifying the presence of the antimicrobial film.

The antimicrobial film-forming composition of the present disclosure can be applied to a variety of surfaces, including any surface that may incur contamination by microorganisms, to form a water-soluble biocidal antimicrobial film. Examples of such surfaces can include, but are not limited to, table and counter tops, food preparation surfaces, surfaces found in publicly used locations and facilities (e.g., public telephones, public transportation, and public lavatory facilities), touch-screen displays, door handles, light switches, and surfaces found in healthcare settings (e.g., bed rails and side tables).

The surface onto which the antimicrobial film-forming composition is applied can be a flat, planar surface, or it can be curved or irregularly shaped.

The terms “microorganism,” “microbe,” or derivatives thereof, are used to refer to any microscopic organism, including without limitation, one or more of bacteria, viruses, algae, fungi and protozoa. In some cases, the microorganisms of particular interest are those that are pathogenic, and the term “pathogen” is used herein to refer to any pathogenic microorganism.

As described above, the antimicrobial film is derived from a film-forming composition that is applied to a surface. The film-forming composition includes a polymer and an antimicrobial agent dissolved, dispersed or suspended in water or a water-based solvent. In some embodiments, the antimicrobial agents are dispersed amongst or within the polymer in a releasable manner, which allows the antimicrobial agents to be released from the antimicrobial film at an effective diffusion rate to reduce microorganism contamination on the surface. In some embodiments, reducing microorganism contamination includes providing biocidal activity.

The term “biocidal” is used to describe an antimicrobial film that kills microorganisms that come into contact with the antimicrobial film. As a result, biocidal activity is distinguishable over systems that merely provide inhibition of microorganism growth, because a film that inhibits growth and/or reproduction of microorganisms does not necessarily kill the microorganisms. In some embodiments, as further taught by the examples, biocidal activity, and particularly, extended or residual biocidal activity (e.g., after a period of 0.167 hrs., after a period of greater than 24 hours, etc.) can be demonstrated by the microbial load reductions exhibited by the antimicrobial film, when tested pursuant to, for example, ASTM E2180-01 and/or JIS Z 2801:2000. In some embodiments, as further taught by the examples, biocidal activity, and particularly, fast-acting biocidal activity can be demonstrated by the biocidal activity exhibited by the film-forming composition, when tested, for example, pursuant to the AOAC International Use-Dilution Test 964.02.

In some embodiments, the film-forming composition is water-based, and the polymer and antimicrobial agent are water-soluble, such that the polymer and the antimicrobial agent are dissolved in water. The film-forming composition can be applied to a surface to form a water-soluble antimicrobial film. The water-soluble antimicrobial film can be resistant to removal by moderate frictional forces in a dry environment, such as frictional forces applied when a user uses a dry wipe article (e.g., a cloth towel or sponge) to wipe food or waste from a surface. This allows the antimicrobial film to provide antimicrobial protection to a surface without the risk of accidentally being removed while the surface is wiped clean.

However, the antimicrobial film is water-soluble, such that moderate frictional forces in a moist or wet environment can remove the antimicrobial film. The term “water-soluble” is used to refer to an antimicrobial film of which at least 70% dissolves (i.e., forms a homogeneous solution) in water with moderate stirring at room temperature. One example of a method for testing water solubility is as follows (and further described in Example 5). A solution of polyvinyl alcohol and blue dye was dispersed in water and a glass slide was dip-coated in the solution. The coated slide was allowed to dry for three days. After the three days at ambient conditions (70° F. (21° C.), 40% relative humidity) the slide was submerged in distilled water with moderate agitation of the water. After 30 seconds the slide was removed from the water, dried, and rated. If at least 70% of the blue dye was removed from the slide, in some embodiments, at least 80%, and in some embodiments, at least 90%, then the antimicrobial film is considered to be “water-soluble.” If after 30 seconds in these conditions, less than 70% of the antimicrobial film, in some embodiments less than 80%, and in some embodiments, less than 90% still remains intact on the glass slide (i.e., less than 70% of the blue dye was removed), the antimicrobial film is considered to be “water-insoluble.”

Because the film-forming composition is water-based (i.e., the solvent of the film-forming composition includes water), and the polymer and antimicrobial agent(s) are water-soluble, an antimicrobial film formed of the film-forming composition can be removed and a fresh antimicrobial film can be laid down merely by re-applying the film-forming composition to a surface comprising the antimicrobial film.

That is, the antimicrobial film of the present disclosure can be “self-stripped” by its corresponding film-forming composition, and each application of the film-forming composition can simultaneously remove a substantial amount of a previously applied antimicrobial film. For example, after a first antimicrobial film is applied to a surface, a second application of the film-forming composition can be used to simultaneously remove the first antimicrobial film and apply a second antimicrobial film. This allows the application and removal of the antimicrobial film to be performed in a single step with a low accumulation of the film-forming composition (e.g., less than 5% weight gain). This can reduce the number of steps and the time required to apply and remove the antimicrobial film.

A portion of the film-forming composition of the first antimicrobial film may be redeposited along with the film-forming composition of the second antimicrobial film, which may reduce the concentration of the antimicrobial agent in the second antimicrobial film. However, concentration of the antimicrobial agent in the film-forming composition may be increased to compensate for this. This increase in concentration of the antimicrobial agent can correspond to the amount of the film-forming composition of the first antimicrobial film that is redeposited (i.e., proportional to any weight gain).

When desired, instead of replenishing the antimicrobial film with a second application of the film-forming composition, the antimicrobial film can be removed from the surface with water or a water-based solvent. After removal of a first antimicrobial film, a fresh application of the film-forming composition can be applied to the surface to provide a second antimicrobial film. When removal of the antimicrobial film is desired, water or a water-based solvent may be applied to the antimicrobial film. In some embodiments, the antimicrobial film can then be wiped off from the surface under moderate frictional forces.

Suitable polymers for use in the film-forming composition include water-soluble polymers, such as polyvinyl alcohols. Suitable commercially available polyvinyl alcohols include those available from J.T. Baker, Phillipsburg, N.J.; from Kuraray America Inc., New York, N.Y.; from Sigma-Aldrich Company, St. Louis, Mo.; and the “CELVOL” product line from Celanese Corporation, Dallas Tex.

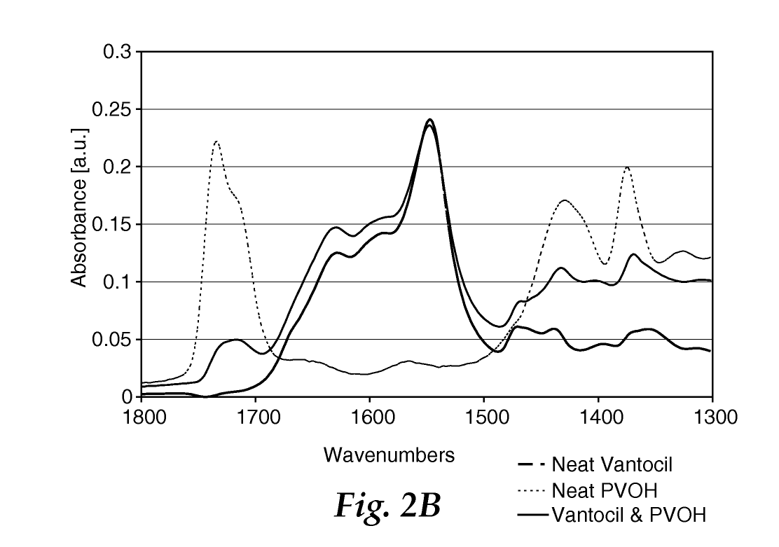

Other water-soluble polymers would function as a water-soluble film-former, but particular utility was found when polyvinyl alcohol was used. In particular, within certain concentrations and molecular weights, the antimicrobial films comprising polyvinyl alcohol gave improved aesthetic and optical properties (see, for example, Example 1). In addition, the antimicrobial films comprising polyvinyl alcohol gave surprisingly good biocidal activity, as shown in the Examples. One possible explanation for this, without wishing to be bound by theory, may be that polyvinyl alcohol does not include a charge and does not interact (e.g., through a Coulomb attraction) with polyhexamethylene biguanide, which it can be theorized does occur between polyvinylpyrrolidone and polyhexamethylene biguanide (see Example 10 and FIGS. 2A and 2B).

Suitable polyvinyl alcohols can have a wide range of molecular weights, where the molecular weight generally determines the product performance. For example, if the polyvinyl alcohol molecular weight is too low, the antimicrobial film may be too tacky and too easily removable (i.e., has poor durability and is too water-soluble to provide adequate residual biocidal activity). Alternatively, if the molecular weight of the polymer is too high, the coating solution can exhibit poor solubility, which results in the film being too difficult to remove for applications where frequent washing or replenishment is typical. For applications in which the antimicrobial film will need to be removed and replenished from time to time, suitable molecular weights provide good film durability and effective biocidal activity, while still providing water-solubility and relative ease of removal with water or a water-based solvent. That is, in some embodiments, an effective molecular weight refers to a molecular weight that allows the antimicrobial film to be water-soluble. For example, in some embodiments, an effective average molecular weight of polyvinyl alcohol is no greater than 80,000 Daltons, in some embodiments, no greater than 10,000, and in some embodiments, no greater than 2,000 Daltons.

Water-soluble materials can be suitable for use in situations where the antimicrobial film remains dry until the intended removal with water or a water-based solvent.

Suitable concentrations of the polymer in the antimicrobial film (i.e., after application and drying of the film-forming composition) include any concentration that is effective for dispersing and containing the antimicrobial agents, without diminishing the aesthetics and optical clarity of the antimicrobial film. In some embodiments, the concentration of the polymer in the antimicrobial film can be at least 50% by weight, in some embodiments, at least 70% by weight, and in some embodiments, at least 90% by weight. In some embodiments, the concentration of the polymer in the antimicrobial film can be no greater than 99.9% by weight, in some embodiments, no greater than 99% by weight, and in some embodiments, no greater than 95% by weight.

To achieve an antimicrobial film with the above polymer concentrations, in some embodiments, the polymer concentration in the film-forming composition is at least 0.5% by weight, in some embodiments, at least 1% by weight, in some embodiments, at least 3% by weight, and in some embodiments, at least 5% by weight. In some embodiments, the polymer concentration in the film-forming composition is no greater than 15% by weight, in some embodiments, no greater than 10% by weight, and in some embodiments, no greater than 5% by weight.

Suitable antimicrobial agents for use in the film-forming composition include any polyhexamethylene biguanide (also sometimes referred to as poly(iminoimidocarbonylimidocarbonyliminohexamethylene) or “PHMB”). Examples of suitable polyhexamethylene biguanides include polyhexamethylene biguanide hydrochlorides (also sometimes referred to as poly(iminoimidocarbonylimidocarbonyliminohexamethylene hydrochlorides), commercially available under the trade designation “VANTOCIL” from Arch Chemicals, Inc., Norwalk, Conn., and commercially available under the trade designation “COSMOCIL” from Arch Chemicals.

A suitable concentration of the antimicrobial agent in the antimicrobial film includes any concentration that is effective for providing biocidal activity, and particularly, biocidal activity to gram positive and gram negative bacteria. This may vary depending on the type of antimicrobial agent used. In some embodiments, the concentration of the antimicrobial agent in the antimicrobial film is at least 0.5% by weight, in some embodiments, at least 1% by weight, in some embodiments, at least 3% by weight, and in some embodiments, at least 5% by weight. In some embodiments, the concentration of the antimicrobial agent in the antimicrobial film is no greater than 50% by weight, in some embodiments, no greater than 25% by weight, in some embodiments, no greater than 15%, and in some embodiments, no greater than 10% by weight.

To achieve an antimicrobial film with the above antimicrobial agent concentrations, in some embodiments, the antimicrobial agent concentration in the film-forming composition is at least 0.05% by weight, in some embodiments, at least 0.1% by weight, in some embodiments, at least 0.5% by weight, in some embodiments, at least 5% by weight, and in some embodiments, at least 10% by weight. In some embodiments, the antimicrobial agent concentration in the film-forming composition is no greater than 15% by weight, in some embodiments, no greater than 5% by weight, and in some embodiments, no greater than 1% by weight.

In some embodiments, the ratio of polymer to antimicrobial agent in the film-forming composition and the percent total solids or the weight percent of polymer (described in greater detail below) is controlled to achieve an antimicrobial film with the above antimicrobial agent concentrations. For example, in some embodiments, the weight ratio of polymer to antimicrobial agent is at least 5:1 by weight, in some embodiments, at least 6:1 by weight, in some embodiments, at least 10:1 by weight, and in some embodiments, at least 15:1 by weight. In some embodiments, the weight ratio of polymer to antimicrobial agent is no greater than 99:1 by weight, in some embodiments, no greater than 75:1 by weight, in some embodiments, no greater than 50:1 by weight, and in some embodiments, no greater than 30:1 by weight.

The film-forming compositions can be formulated based on the desired viscosity, which is largely due to the amount of polymer in the film-forming composition. In some embodiments, the film-forming composition includes no greater than 20 weight percent of polymer, in some embodiments, no greater than 10 weight percent of polymer, in some embodiments, no greater than 5 weight percent of polymer, and in some embodiments, no greater than 3 weight percent of polymer. The weight percent of biocide to be added to the film-forming composition can then be calculated using the desired ratio of polymer to antimicrobial agent in the resulting antimicrobial film.

Because the polymer and antimicrobial agent of the film-forming composition of the present disclosure have been selected so as not to have any significant interaction with one another, a lower concentration of the antimicrobial agent can be used in the film-forming composition. A lower concentration of the antimicrobial agent can lead to reduced cost, reduced environmental impact (if any), and an antimicrobial film that has improved aesthetic properties.

A “sufficiently available” antimicrobial agent or a “sufficient surface concentration” of the antimicrobial agent in the antimicrobial film is sometimes used to refer to an antimicrobial film having microbial load reductions of at least 99% against gram positive or gram negative bacteria when tested pursuant to, for example, one or both of ASTM E2180-01 and JIS Z 2801:2000, and more particularly, microbial load reductions of at least 99% against gram positive and gram negative bacteria when tested pursuant to, for example, one or both of ASTM E2180-01 and JIS Z 2801:2000. In some embodiments, the antimicrobial film of the present disclosure has microbial load reductions of at least 99.9% against gram positive and gram negative bacteria when tested pursuant to, for example, one or both of ASTM E2180-01 and JIS Z 2801:2000.

The film-forming composition may also include an additional fast-acting antimicrobial agent that may not provide antimicrobial activity over extended periods of time, but which can provide fast antimicrobial activity (e.g., at least 99% microbial load reduction in gram negative or gram positive bacteria in 30 minutes or less in some embodiments, and/or biocidal activity in 5 minutes or less in some embodiments) of a relatively short duration upon application of the film-forming composition to a surface and before drying of the film forming composition. In some embodiments, the antimicrobial agent in the film-forming composition can have fast-acting and residual biocidal activity and no additional fast-acting antimicrobial agent is necessary. For example, polyhexamethylene biguanide has fast-acting and residual biocidal activity. However, an additional fast-acting antimicrobial agent can still be added to the film-forming composition to improve the fast-acting biocidal activity of the film-forming composition.

Examples of suitable fast-acting antimicrobial agents that can be used in addition to polyhexamethylene biguanide include quaternary ammonium salts, benzalkonium chlorides, biguanide compounds (e.g., halogenated hexidines such as chlorhexidine, chlorhexidine gluconate, and chlorhexidine acetate), alcohols (e.g., low molecular weight alcohols such as ethyl alcohol and isopropyl alcohol), bleach, hydrogen peroxide, urea hydrogen peroxide, hydrogen peroxide stabilized in a sodium pyrophosphate matrix, hydrogen peroxide chelated in polyvinylpyrrolidone, and combinations thereof. Examples of suitable commercially available quaternary ammonium salts include didecyl dimethyl ammonium chlorides available under the trade designation “BTC 1010” from Stepan Company, Northfield, Ill., and under the trade designation “BARDAC 2250” from Lonza Group Ltd., Basel, Switzerland; dialkyl dimethyl ammonium chlorides available under the trade designation “BARDAC 2050 also from Lonza Group Ltd.; alkyl dimethyl benzyl ammonium chloride available under the trade designation “BARQUAT MB-50” also from Lonza Group Ltd; and n,n-dialkyl-n,n-dimethyl ammonium bicarbonate/carbonate available under the trade designation “CARBOSHIELD 1000” from Lonza Inc., Allendale, N.J.

Suitable concentrations of the fast-acting antimicrobial agents in the film-forming composition include any concentration that is effective for reducing microbial contamination upon application of the film-forming composition, and may depend on the type of fast-acting antimicrobial agent used. For example, when the fast-acting antimicrobial agent is an alcohol, in some embodiments, the concentration of the alcohol in the film-forming composition ranges from 60% by weight to 90% by weight, and in some embodiments, from 70% by weight to 80% by weight. By way of further example, when the fast-acting antimicrobial agent is a quaternary ammonium compound, in some embodiments, the concentration of the quaternary ammonium compound ranges from 0.001% by weight to 10% by weight, and in some embodiments, from 0.1% by weight to 5% by weight.

A suitable concentration of the fast-acting antimicrobial agent in the antimicrobial film includes any concentration that is effective for providing fast-acting biocidal activity, which may vary depending on the type of antimicrobial agent used. For example, in some embodiments employing a quaternary ammonium compound as the fast-acting antimicrobial agent, the concentration of the fast-acting antimicrobial agent in the antimicrobial film can be at least 0.5% by weight, in some embodiments, at least 1% by weight, in some embodiments, at least 3% by weight, and in some embodiments, at least 5% by weight. In some embodiments, the concentration of the fast-acting antimicrobial agent in the antimicrobial film is no greater than 50% by weight, in some embodiments, no greater than 25% by weight, in some embodiments, no greater than 15%, and in some embodiments, no greater than 10% by weight.

In addition, the ratio of polymer to fast-acting antimicrobial agent in the film-forming composition and the percent total solids or the weight percent of polymer (described above) is controlled to achieve an antimicrobial film with the above antimicrobial agent concentrations. For example, in some embodiments, the weight ratio of polymer to antimicrobial agent is at least 5:1 by weight, in some embodiments, at least 6:1 by weight, in some embodiments, at least 10:1 by weight, and in some embodiments, at least 15:1 by weight. In some embodiments, the weight ratio of polymer to antimicrobial agent is no greater than 99:1 by weight, in some embodiments, no greater than 75:1 by weight, in some embodiments, no greater than 50:1 by weight, and in some embodiments, no greater than 30:1 by weight.

The film-forming composition may also include surfactants and thickeners to modify wetting and/or flow properties. Examples of suitable surfactants include the trade designated “SURFONIC L” series surfactants commercially available from Huntsman Corporation, Salt Lake City, Utah; the trade designated “ZONYL” surfactants commercially available from E. I. du Pont de Nemours and Company; and the trade designated “GLUCOPON” series non-ionic surfactants, commercially available from Cognis Corporation, Cincinnati, Ohio, such as the trade designated “GLUCOPON 425 N” surfactant, which is a mixture of alkyl polyglycosides and cocoglucosides. Examples of suitable thickeners include starch, gum arabic, guar gum, and carboxymethylcellulose. A particularly suitable thickening agent is commercially available under the trade designation “NEOCRYL-A1127” from DSM NeoResins, Wilmington, Mass. In some embodiments, the total concentration of surfactants and/or thickeners in the film-forming composition is at least 0.05% by weight, in some embodiments, at least 0.1% by weight, and in some embodiments, at least 0.5% by weight. In some embodiments, the total concentration of surfactants and/or thickeners in the film-forming composition is no greater than 5% by weight, in some embodiments, no greater than 2% by weight, and in some embodiments, no greater than 1% by weight.

In some embodiments, one or more surfactants can be added to the film-forming composition to improve the cleanability of the film-forming composition. In some embodiments, the “cleanability” of the film-forming composition can be determined pursuant to ASTM D5342-06 cleaning test protocol. Such “cleanability” is exemplified in Example 15.

Additional optional components that may be incorporated into the film-forming composition include buffering agents and pH adjusting agents, fragrances or perfumes, dyes and/or colorants, solubilizing materials, defoamers, lotions and/or mineral oils, essential oils, enzymes, bleaching agents, preservatives, indicator dyes, and combinations thereof. In some embodiments, the total concentration of the optional components in the film-forming composition can range from 1% by weight to 20% by weight, and in some embodiments, from 1% by weight to 5% by weight.

In some embodiments, the film-forming composition can further include a dye to allow color tinting of the resulting antimicrobial film. Tinted films allow the end user to visually verify the film coverage of the surface, and, after applying water or a water-based solvent, can be used to visually verify that all of antimicrobial film was removed from the surface.

Furthermore, in some embodiments, the film-forming composition can include one or more indicator dyes that provide color to the film-forming composition, thereby allowing a user to visually verify the film coverage of the surface. However, the indicator dye used can be of the type that the color disappears upon drying (e.g., upon exposure to air) within a short time period (e.g., few seconds or minutes) leaving a colorless antimicrobial film. Examples of suitable indicator dyes include, but are not limited to, pH indicator dyes based on phthalein chemistry, such as phenolphthalein (pink), thymolphthalein (blue), and o-cresolphthalein (purple), m-nitrolphenol, ethyl bis(2,4-dinitrophenyl)acetate, all of which are obtainable from Sigma-Aldrich Chemical Company, Saint Louis, Mo.

Such indicator dyes can also allow a user to check that the antimicrobial film is still intact by applying a trigger composition to the surface that is known to trigger the indicator dye to show color. For example, in some embodiments, if the antimicrobial film including the indicator dye is still intact on the surface, and the indicator dye is pH-sensitive, the antimicrobial film will change color upon applying a trigger composition that includes water (i.e., pH 7), a high pH solution (e.g., WINDEX®-brand glass cleaner solution), an ammonia solution, or whatever substance to which the indicator dye is sensitive. This would indicate to the user, for example, that the antimicrobial film is still applied to the surface of interest, and can also give an estimate of the level and/or consistency of the antimicrobial film's coverage.

By way of example only, one way of adding an indicator dye to the film-forming composition is by adding the indicator dye to a soap solution to form a dyed soap solution that can then be combined with the film-forming composition, as explained in greater detail in Example 2. For example, such a dyed soap solution can be added to the film-forming composition in an amount of at least 1% by weight, in some embodiments, at least 3% by weight, and in some embodiments, at least 5% by weight. In some embodiments, the dyed soap solution can be added to the film-forming composition in an amount of no greater than 20% by weight, in some embodiments, no greater than 5% by weight, and in some embodiments, no greater than 1% by weight.

Similar verification of the presence of an antimicrobial film can be provided by incorporating other types of indicator dyes in the film-forming composition, such as ultraviolet (UV)-sensitive indicator dyes. Examples of suitable UV-sensitive indicator dyes include, UV-fluorescent dyes that absorb electromagnetic radiation in the UV spectrum and fluoresce. Examples of suitable classes of UV-fluorescent dyes include, but are not limited to, triazine-stilbenes (e.g., di-, tetra- or hexa-sulfonated), coumarins, imidazolines, diazoles, triazoles, benzoxazolines, biphenyl-stilbene, luciferins, and combinations thereof. For example, in some embodiments, the UV-fluorescent dye can include, but is not limited to, umbelliferone (commercially available from Sigma-Aldrich, St. Louis, Mo.) leucophor (commercially available from Clarient, Charlotte, N.C.), luciferin (commercially available from Pierce, Rockford, Ill.), and a combination thereof.

Such UV-fluorescent dyes can also allow a user to check that the antimicrobial film is still intact by triggering the antimicrobial film by irradiating the film with UV radiation. For example, in some embodiments, the film-forming composition can include a UV-fluorescent dye, and can appear clear, colorless and without fluorescence. If the film-forming composition is, however, exposed to UV radiation, the film-forming composition will fluoresce. The film-forming composition comprising the UV-fluorescent dye can be applied to a surface to form an antimicrobial film and dried. The presence of the antimicrobial film on the surface can be verified at any time by exposing the antimicrobial film to UV radiation to cause the UV-fluorescent dye to fluoresce and become visible. This would indicate to the user, for example, that the antimicrobial film is still applied to the surface of interest, and can also give an estimate of the level and/or consistency of the antimicrobial film's coverage.

The film-forming composition can be formed by blending the antimicrobial agent, the polymer, and any optional components together. This may be performed as a solution in a solvent, where the solvent is selected to substantially dissolve or disperse the antimicrobial agent, the polymer, and any optional components. In such solution embodiments, the solids concentration in the solvent of the film-forming composition is at least about 0.5%, in some embodiments, at least about 1%, and in some embodiments, at least about 3%. In some embodiments, the solids concentration in the solvent of the film-forming composition is no greater than 10%, in some embodiments, no greater than 5%, in some embodiments, no greater than 3%, and in some embodiments, no greater than 2%. For example, in some embodiments, the ratio of polymer to antimicrobial agent is 99:1 and the percent solids (or the weight percent polymer) in the film-forming composition is 3%. In some embodiments, the ratio of polymer to antimicrobial agent is 32:1 and the percent solids (or the weight percent polymer) in the film-forming composition is 3%. By further way of example only, in some embodiments, the ratio of polymer to antimicrobial agent is 19:1 and the percent solids (or the weight percent polymer) in the film-forming composition is 1-2%, and finally, by way of example only, in some embodiments, the ratio of polymer to antimicrobial agent is 6:1 and the total percent solids in the film-forming composition is 3.5%.

As mentioned above, the film-forming composition may be applied to a surface and dried to form the antimicrobial film. The film-forming composition may be applied to the surface in a variety of manners, including, but not limited to, spraying; brushing; coating (e.g., rod coating, notch coating, and combinations thereof); wiping the film-forming composition onto the surface with a wipe, a sponge, or the like; and combinations thereof.

In embodiments employing a wipe, the film-forming composition can be impregnated within the substrate of the wipe, or the film-forming composition can be sprayed onto a surface and spread with the wipe. As a user wipes a wipe that has been impregnated with the film-forming composition across the surface, the film-forming composition is extracted from the substrate of the wipe and is deposited onto the surface and dried to form a thin, continuous antimicrobial film on the surface.

A variety of drying techniques can be used to remove the solvent to form the antimicrobial film, including, but not limited to, air drying (e.g., forced or passive) at room temperature or elevated temperatures (e.g., in an oven with stagnant or forced air). The use of volatile solvents (e.g., isopropanol and acetone) can be added to the solvent of the film-forming composition to increase the rate of drying. After drying, the resulting antimicrobial film is a thin, continuous film having a thickness sufficient to provide an antimicrobial surface concentration that provides biocidal activity. In some embodiments, the thickness of the antimicrobial film on the surface is at least 1 micrometer, and in some embodiments at least 2 micrometers. In some embodiments, the thickness of the antimicrobial film on the surface is no greater than 100 micrometers, in some embodiments, no greater than 50 micrometers, in some embodiments, no greater than 10 micrometers, and in some embodiments, no greater than 1 micrometer. In some embodiments, the antimicrobial film is also a transparent film, which allows the aesthetic qualities of the underlying surface to be visually observed through the antimicrobial film.

In some embodiments, the antimicrobial film can include an end-of-service indicator to provide visual indication prompting the user to replace the antimicrobial film. Examples of suitable end-of-service indicators include time-temperature indicators and color changing dyes. An end-of-service indicator can be applied, for example, to the antimicrobial film in the form of a label or paint to the corners of the antimicrobial film after the antimicrobial film has been formed on a surface. In some embodiments, the indicator is calibrated to indicate a color change at about the time when the corresponding antimicrobial film should be replaced (e.g., when the antimicrobial activity levels have substantially decreased or are exhausted).

Time-temperature indicators typically operate by chemical reaction mechanisms, diffusion mechanisms, and capillary driven, fluid-wicking mechanisms. Examples of suitable time-temperature indicators are disclosed in Bommarito, et al., U.S. Pat. No. 6,741,523 (i.e., microstructured time-dependent indicators) and Arens, et al., U.S. Pat. No. 5,667,303, both of which are incorporated by reference in their entireties, and in The Wiley Encyclopedia of Packaging Technology, 400-406 (John Wiley & Sons, 1986) under the section entitled “Indicating Devices”. Examples of suitable commercially available time-temperature indicators include those sold under the trade designations “MONITOR MARK” from 3M Company, St. Paul, Minn.; “WARM MARK” from Dry Pak Industries, Studio City, Calif.; “FRESH CHECK” from Lifelines Technology Inc., Morris Plains, N.J.; “VISTAB” from Visual Indicator Tag Systems AB, Malmö, Sweden; and “TT MONITOR” from Avery Dennison Corporation, Pasadena, Calif.

As mentioned above, water or a water-based solvent can be used to remove the antimicrobial film from a surface. A water-based solvent can include a variety of solvents and can be selected to closely match the solubility parameter of the polymer used. The term “solubility parameter” herein refers to the Hildebrand solubility parameter (δ), which is a solubility parameter represented by the square root of the cohesive energy density of a material, having units of (pressure)^{1/2}, and being represented by the following equation:

$$δ = \sqrt{( \frac{Δ H - RT}{V} )} \qquad ( 1 )$$

where ΔH is the molar vaporization enthalpy of the material, R is the universal gas constant, T is the absolute temperature, and V is the molar volume of the solvent. Hildebrand solubility parameters are generally provided in conventional units of (calories/centimeter³)^{1/2} ((cal/cm³)^{1/2}) and in SI units of megaPascals^{1/2} (MPa^{1/2}).

Hildebrand solubility parameters are tabulated for solvents in Barton, A. F. M., Handbook of Solubility and Other Cohesion Parameters, 2^{nd} Ed. CRC Press, Boca Raton, Fla., (1991), for monomers and representative polymers in Polymer Handbook, 3^{rd} Ed., J. Brandrup & E. H. Immergut, Eds. John Wiley, NY pp. 519-557 (1989), and for many commercially available polymers in Barton, A. F. M., Handbook of Polymer-Liquid Interaction Parameters and Solubility Parameters, CRC Press, Boca Raton, Fla., (1990). In some embodiments, the difference in Hildebrand solubility parameters between the polymer in the film-forming composition and the solvent include differences of about 5.0 ((cal/cm³)^{1/2} or less, in some embodiments, about 2.0 ((cal/cm³)^{1/2} or less, and in some embodiments, about 1.0 ((cal/cm³)^{1/2}.

Examples of suitable water-based solvents include water and any of the following: low molecular weight alcohols (e.g., ethanol, methanol, etc.), or other polar solvents; volatile solvents (e.g., acetone and isopropanol); glycol ethers; isoprene based solvents; solvent microemulsions; water miscible alcohols, ketones, esters, ethers, or the like; and combinations thereof. In some embodiments, a water-based solvent with a minimally objectionable odor is employed.

The water-based solvent may also include a variety of additives, such as surfactants, thickeners, and/or foaming agents to modify wetting and flow properties. Examples of suitable surfactants and thickeners include those discussed above for the film-forming composition. In some embodiments, the total concentration of additives in the solvent is at least 0.5% by weight, and in some embodiments, at least 5% by weight. In some embodiments, the total concentration of additives in the solvent is no greater than 20% by weight, and in some embodiments, no greater than 10% by weight.

In some embodiments, the water-based solvent is sprayed onto the antimicrobial film, and in some embodiments, the water-based solvent is impregnated into a wipe. In such embodiments, as the user applies frictional force to the antimicrobial film with a wipe, the solvent is extracted from the wipe and deposited onto the antimicrobial film to dissolve the polymer in the antimicrobial film, thereby allowing the antimicrobial film to be wiped away from the surface.

In embodiments employing a wipe, either in application of the film-forming composition or a solvent to remove the antimicrobial film, the substrate of the wipe can be formed of any type of woven, non-woven, knitted, foam, or sponge substrate, or combinations thereof (e.g., that is capable of being impregnated with the film-forming composition or the solvent). The substrate may consist of a single layer or multiple layers of one or more materials. Non-woven substrates are particularly suitable because of their utility in the manufacture of cleaning and scouring articles.

Because the film-forming composition or the solvent is extracted from the substrate during use, the wipe is particularly suitable as a disposable wipe (i.e., the wipe may be formed from substrate materials intended to be discarded after use). Examples of suitable disposable substrate materials for the wipe include, but are not limited to, spun-bond and spun-lace non-woven materials having a basis weight ranging from about 15 grams/meter² to about 75 grams/meter². Such materials can be made of synthetic polymers, natural polymers, and combinations thereof. Suitable synthetic polymers can include rayon polyester, polyethylene terephthalate (PET), polyvinyl chloride, polyacrylamide, polystyrene, polyethersulfone, acrylics and acrylic copolymers, rayon, polyolefins (e.g., polypropylene), and combinations thereof. Suitable natural polymers can include poly(lactic acid) (PLA), poly(glycolic acid) (PGA), wood pulp, cotton, cellulose, rayon, and combinations thereof

Alternatively, the substrate of the wipe can be formed of materials used for semi-disposable or reusable wipes. Examples of suitable semi-disposable substrate materials for the wipe include, but are not limited to, spun-lace non-woven materials having a basis weight ranging from about 75 grams/meter² to about 250 grams/meter². Such materials may be formed from fibers or microfibers of polyester, polyamide, viscose, or combinations thereof. Examples of suitable reusable wipe materials for the substrate of the wipe include, but are not limited to, knitted, woven, thermo-bonded, latex-coated, and chamois-type materials having a basis weight ranging from about 100 grams/meter² to about 300 grams/meter². Such materials may be formed from fibers or microfibers of polyester, rayon, viscose, polypropylene, natural fibers, polyamides, PLA, PGA, or combinations thereof.

Examples of suitable commercially available wipes include those sold under the trade designation “SONTARA”, non-woven fabrics available from Du Pont such as SONTARA 8001 (100% polyester substrate) and SONTARA 8100 (50% polyester/50% Dacron). Other suitable wipes include those designated as M001, M022, and M017, and are 100% spunlaced polyester materials available from Polymer Group Inc., Wilmington, Del. Biodegradable materials can be used such as non-woven wipes made of PLA, commercially available under the trade designation “INGEO” from NatureWorks, LLC, Minnetonka, Minn. Other polyester wipe materials can be obtained from Jacob Holms Industries under the designation 350160 and 10203-003.

In some embodiments, the wipe is textured. An example of a suitable textured wipe is described in Johnson, et al., U.S. Publication No. 2005/0272335 (i.e., consumer scrubbing wipe article and method of making same), which is incorporated herein by reference.

In some embodiments, the wipe is glove-shaped and dimensioned to receive a hand of the user. This can provide a convenient means for the user to wipe the wipe across a surface. In some embodiments, the glove-shaped wipe includes a barrier layer (e.g., a flexible polymeric layer) between the substrate containing the film-forming composition or the solvent and the hand of the user. This can inhibit contact between the film-forming composition or the solvent and the hand of the user. However, the film-forming compositions and solvents of the present disclosure are generally pH neutral and non-irritating to the skin, allowing them to be used frequently in a variety of applications without cumbersome safety garments or equipment.

In some embodiments, the concentration of the film-forming composition or the solvent in the wipe, prior to extraction, is at least 50%, and in some embodiments, is at least 100% by weight of the substrate, based on the dry weight of the substrate. In some embodiments, the concentration of the film-forming composition or the solvent in the wipe, prior to extraction, is no greater than 500%, and in some embodiments, is no greater than 400% by weight of the substrate, based on the dry weight of the substrate.

The film-forming composition or the solvent can be impregnated within the wipe substrate in a variety of manners, such as spraying, knife coating, roll coating, curtain coating, spin coating, immersion coating, dip coating, and combinations thereof. After impregnation and prior to use, the wipe is at least partially saturated with the film-forming composition or the solvent. The resulting wipe may then be packaged in a sealed environment (individually or with multiple articles) to prevent the solvent from evaporating. When the user desires to apply or remove an antimicrobial film onto or from a surface, the user can wipe the wipe across the surface while applying a moderate amount of pressure. The applied pressure and the frictional force imposed by the wiping action causes portions of the film-forming composition or the solvent to deposit from the substrate of wipe to the surface. In the case of applying the film-forming composition, the polymer, the antimicrobial agent, and the solvent of the film-forming composition are each deposited from the wipe. This is in contrast to conventional antimicrobial wipes, in which only an antimicrobial (and typically a solvent) are deposited. By depositing the polymer with the antimicrobial agent and the solvent, an antimicrobial film is formed in which the polymer functions to hold the antimicrobial agent on the surface and inhibit the antimicrobial agent from being immediately wiped away when the surface is wiped in a dry environment.

The amount of film-forming composition or solvent extracted can be dependent on the pressure applied, the extent of the wiping action, and the concentration of the film-forming composition impregnated within the substrate of the wipe. After use, the wipe may be discarded. Alternatively, if the wipe retains a useable portion of the impregnated film-forming composition or solvent, the wipe may be reused to apply or remove antimicrobial films to or from additional surfaces until the film-forming composition or solvent has been depleted from the wipe. Accordingly, the wipe may be used as a disposable or semi-disposable wipe article. In some embodiments, the wipe can be re-impregnated with an additional supply of the film-forming composition or the solvent for subsequent use, which can increase the product life of the wipe.

The following working examples are intended to be illustrative of the present invention and not limiting.

### Examples

Unless otherwise noted, all parts, percentages, and ratios reported in the following examples are on a weight basis, and all reagents used in the examples were obtained, or are available, from the chemical suppliers described below, or may be synthesized by conventional techniques.

The following compositional abbreviations are used in the following Examples:
“Vantocil P”: A poly(iminoimidocarbonylimidocarbonyliminohexamethylene hydrochloride) (PHMB), pH 5-6, 20% by weight active (i.e., Vantocil 100) in water, commercially available under the trade designation “VANTOCIL P” from Arch Chemicals, Inc., Norwalk, Conn.
“Vantocil IB”: A poly(iminoimidocarbonylimidocarbonyliminohexamethylene hydrochloride) (PHMB), pH 4-5, 20% by weight active in water, commercially available under the trade designation “VANTOCIL IB” from Arch Chemicals, Inc., Norwalk, Conn.
“Vantocil 100” A poly(iminoimidocarbonylimidocarbonyliminohexamethylene hydrochloride) (PHMB), pH 4-5, 96% by weight active, commercially available under the trade designation “VANTOCIL 100” from Arch Chemicals, Inc., Norwalk, Conn.
“PVOH-2k”: A polyvinyl alcohol polymer having an average molecular weight of 2,000 Daltons and a degree of hydrolysis of 75%, commercially available from Sigma-Aldrich Chemical Company, Saint Louis, Mo.
“PVOH-403”: A polyvinyl alcohol polymer having an average molecular weight of 14,000 Daltons and a degree of hydrolysis of 80.2%, commercially available from Kuraray America Inc., New York, N.Y.
“PVOH-26-88”: A polyvinyl alcohol polymer having an average molecular weight of 160,000 Daltons and a degree of hydrolysis of 86.7%, commercially available from Kuraray America Inc., New York, N.Y.
“PVP-K90”: A polyvinylpyrrolidone polymer having an average molecular weight of 1.2 million Daltons, which is commercially available under the trade designation “PVP-K90” from International Specialty Products, Wayne, N.J.
“PVP-K30” A polyvinylpyrrolidone polymer having an average molecular weight of 58,000 Daltons, which is commercially available under the trade designation “PVP-K30” from International Specialty Products, Wayne, N.J.
“Sulfonated PUD” A 30% solids sulfonated polyurethane dispersion, created experimentally by 3M Company, available upon request from 3M Company, St. Paul, Minn.
“Novapharm Triclosan” A disinfectant coating composition containing 0.2% Triclosan (a phenol based biocide), PVP (polyvinylpyrrolidone), and 6% hydrogen peroxide, which is commercially available under the trade designation “HARD SURFACE DISINFECTANT CLEANER” from Novapharm Research (Australia) Pty Limited, New South Wales, Australia.
“Spray Nine” A disinfectant composition comprising a quaternary ammonium compound, which is commercially available under the trade designation “SPRAY NINE®” from Spray Nine Corporation, Johnstown, N.Y.
“PET film”: A polyethylene terephthalate film with acrylate-primed layer, commercially available from Mitsubishi, Japan.
“Neutral Cleaner solution” A 0.05% surfactant based cleaning solution, commercially available under the trade designation “3M Twist 'n Fill #3H Neutral Cleaner” from 3M Company, St. Paul, Minn. The product is diluted from a concentrate through the 3M Twist'n Fill dispenser at a dilution rate of 394:1.
“scrubby wipe”: A textured wipe, commercially available under the trade designation “3M SCOTCH-BRITE Disinfecting Scrubby Wipes” from 3M Company, St. Paul, Minn. The scrubby wipes used in the Examples are the raw version of the scrubby wipe; that is, the scrubby wipes were not previously loaded with any other disinfectant or cleaning solution.
“Carbowax 8000” A polyethyleneoxide polymer having an average molecular weight of 8000 Daltons, commercially available under the trade designation “CARBOWAX 8000” from The Dow Chemical Company, Midland, Mich.
“Celvol 203S” A polyvinyl alcohol polymer having an average molecular weight of 13,000 to 25,000 Daltons, commercially available under the trade designation “CELVOL 203S” from Celanese Corporation, Dallas, Tex.
“Luviskol VA64 W” A polyvinylpyrrolidone/vinyl acetate 60/40 copolymer, commercially available under the trade designation “LUVISKOL VA64 W” from BASF Corporation, Ludwigshafen am Rhein, Rhineland-Palatinate, Germany.
“Acumer 1000” A sodium salt of polyacrylic acid having an average molecular weight of 2000 Daltons, commercially available under the trade designation “ACUMER 1000” from Rohm and Haas Company, Philadelphia, Pa.
“Stance”: A zinc cross-linked acrylic plus polyethylene wax dispersion, commercially available under the trade designation “STANCE” from 3M Company, St. Paul, Minn.
“Orcabrite Blue” A blue dye commercially available under the trade designation “Orcabrite Blue 2GN 2025” from Organic Dyestuffs Corporation, Concord, N.C.
“dioctylsulfosuccinate” 75% dioctylsulfosuccinate, commercially available under the trade designation “AEROSOL OT 75” from Cytec Industries, Inc., West Paterson, N.J.
“CarboShield” A 50% aqueous solution of n,n-dialkyl-n,n-dimethyl ammonium bicarbonate/carbonate, commercially available under the trade designation “CARBOSHIELD 1000” or “CARBOQUAT MW50” from Lonza Inc., Allendale, N.J.
A surfactant formed of a mixture of alkyl polyglycosides and cocoglucosides, commercially available under the trade designation “GLUCOPON 425 N” from Cognis Corporation, Cincinnati, Ohio.
“3M Cleaner” A cleaning product, commercially available under the trade designation “3M General Purpose Cleaner (No. 9)” from 3M Company, St. Paul, Minn.
“3M Mark Remover” A cleaning product, commercially available under the trade designation “3M Heavy Duty Multi-Surface Mark Remover (No. 2)” from 3M Company, St. Paul, Minn.

### Example 1

### Self-Stripping and Optical Properties

Composition 1: A film-forming composition comprising 10,000ppm (1%) PHMB was prepared by combining 1 part by weight Vantocil 100, 10 parts by weight PVOH-2k and 90 parts by weight DI water. That is, a film-forming composition was formed comprising a calculated weight percent of PVOH of 10%, a calculated weight percent of PHMB of 1%, and a calculated weight percent of DI water of 89%.

Comparative Composition A: Novapharm Triclosan.

Comparative Composition B: Spray Nine.

Composition 1 and Comparative Compositions A and B were each applied to a scrubby wipe. Specifically, 5 g of each composition was loaded into a scrubby wipe by homogenously pipetting the solution onto the wipe. The loaded wipe was saturated with the composition but not dripping.

The loaded wipes were wiped onto the surface of PET film, and the PET film was weighed before and after wiping to determine any weight gain due to the application of the composition. Specifically, the scrubby wipes comprising Film-forming Composition 1, Comparative Composition A or Comparative Composition B were wiped onto the PET film in a circular manner (3, 10, 20, and 30 cycles) covering an approximate surface area of 3×3 inch. No measurable weight gain (i.e., weight gain was 0.00 g) was observed after three, 10, 20 and 30 cycles of wiping.

The antimicrobial films of Composition 1 and Comparative Compositions A and B were each tested for “microbial load reduction” pursuant to ASTM E2180-01, which involved inoculation of a molten (45° C.) agar slurry with a standardized culture of bacterial cells. A thin layer of the inoculated agar slurry (0.5 milliliter) was then pipetted onto the test material and the untreated control material. Samples were tested in duplicate using Staphylococcus aureus (ATCC 6538; “gram positive”) and Pseudomonas aeruginosa (ATCC 9027; “gram negative”). After 24 hours, surviving microorganisms were recovered via elution of the agar slurry inoculum from the test substrate into D/E Neutralizing broth and extracted by sonication and vortexing. Serial dilutions were then made, and pour plates were made of each dilution. Agar plates were incubated for 48 hours at 28° C.±1° C. Bacterial colonies from each dilution series were then counted and recorded. Calculation of percent reduction of bacteria from treated versus untreated samples was then made. A percent reduction greater than 99.95% was reported as 100%.

Table 1 lists the microbial load reductions for each composition. The ASTM E2180-01 microbial load reductions testing was performed on a PET film that had been wiped with the three compositions. The results are shown below:

TABLE 1

| | % reduction | % reduction |
|---|---|---|
| | of S. aureus | of P. aeruginosa |
| Sample | (gram positive) | (gram negative) |
| Composition 1 | 99 | 100 |
| Comparative | 100 | −267 |
| Composition A | | |
| Comparative | 100 | −2.9 |
| Composition B | | |

Visual observations of the PET films wiped with the three compositions indicate that Film-forming Composition 1 does not leave any observable residue, while Comparative Compositions A and B resulted in a streaky (Comparative Composition A) and blotchy (Comparative Composition B) appearance that became worse with increasing number of wipes.

Optical interferometry was used to quantify the residue on the PET film from each composition. To prepare the samples for optical interferometry, three PET films were divided into two parts using a black permanent marker. For Film-forming Composition 1, one side of a PET film was wiped 30 times with Film-forming Composition 1, and the other side was not wiped and used as a control. For each of Comparative Compositions A and B, one side of the PET film was wiped once with the respective composition, and the other side was not wipe and used as a control.

A WYKO NT9800 optical interferometer (available from Veeco Instruments, Woodbury, N.Y.) was used in VSI mode using a 50× objective with a field-of-view of 1.0 and a 2% modulation threshold. The backscan and length were both set to 10 micrometers and varied as necessary to obtain the most complete dataset of surface information. The data were visualized and corrected using Vision for Profilers Version 3.44 software (available from Veeco Instruments). The optical interferometry results for each composition are listed in Table 2. The values reported in Table 2 represent the average of the roughness parameters (in nm) measured three times at each of three randomly chosen sites on each sample. When collecting the roughness parameter values, the data restore option was turned off, and the tilt shape terms were removed from all data.

TABLE 2

| | Average roughness Parameter (nm) | |
|---|---|---|
| Sample | Wiped side | PET control (not wiped) |
| Composition 1 | 16.6 +/− 0.2 | 16.8 +/− 0.8 |
| Comparative Composition A | 22 +/− 3.4 | 13 +/− 1 |
| Comparative Composition B | 20 +/− 20 | 11 +/− 0.5 |

Even after only being wiped one time, each of Comparative Composition A and Comparative Composition B exhibited large variability in surface optics, which was indicative of the haze, streaks and/or uneven surface of the comparative compositions. However, after being wiped 30 times, the Film-forming Composition 1 exhibited an average roughness parameter that was not significantly different from the control, with much lower variability than the comparative compositions.

Optical clarity and haze of each composition were evaluated using a UV-vis spectrophotometer (Model Lambda 19, available from Perkin Elmer, Waltham, Mass.). Each of the PET films (comprising either the Film-forming Composition 1, Comparative Composition A, or Comparative Composition B) was placed in the UV-vis spectrophotometer, which was fitted with a film holder.

Table 3 shows the percent transmission of visible light at two wavelengths (600 nm and 400 nm) for each composition. The higher the percent transmission, the greater the optically clarity. Each transmission spectrum has a variation of about ±1%, so Composition 1 was clearly distinguishable from Comparative Compositions A and B.

TABLE 3

| | % Transmission | % Transmission |
|---|---|---|
| Sample | (600 nm) | (400 nm) |
| Composition 1 | 92 | 90 |
| Comparative Composition A | 88 | 86 |
| Comparative Composition B | 85 | 84 |

### Example 2

### Method of Verifying Presence of Antimicobial Film Using an Indicator Dye

A generic soap solution was made by mixing 75 g of DI water with 25 g of a 20% solids sodium laureth sulfate (available from Bethesda Research Laboratories, Gaithersburg, Md.) solution. The soap solution was mixed briefly to ensure homogeneity. 3 g of a 5% NaOH solution was added to the soap solution to raise the pH. 0.4 g of o-cresolphthalein was added to the soap solution to function as an indicator dye. The soap solution was stirred until the dye was completely dissolved. The resulting soap solution was a deep violet (“dyed soap solution”) and remained stable until it was discarded approximately two months after being formed.

Three vol % of the dyed soap solution was added to an aqueous film forming composition comprising 10 weight percent Vantocil 100 and 5 weight percent PVOH-2k to form a violet-colored film-forming composition (“the dyed film-forming composition”).

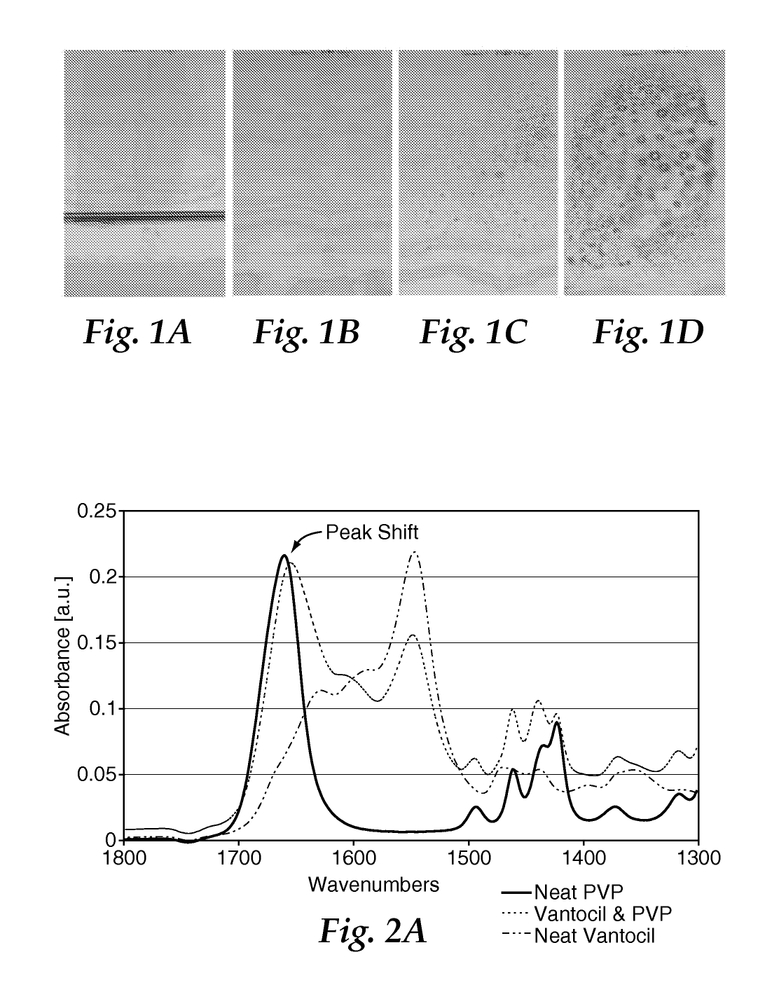

As shown in FIG. 1A, the dyed film-forming composition was coated onto a PET film using a wire wound rod #3 to form an antimicrobial film. After about 20 seconds, the color of the dye had completely disappeared from the antimicrobial film, and the antimicrobial film remained colorless and transparent, as shown in FIG. 1B. Spraying various amounts of WINDEX®-brand glass cleaner solution onto the coating reactivated the dye in the antimicrobial film and caused it to exhibit a violet color again, as shown in FIGS. 1C and 1D. The violet color again disappeared as the WINDEX®-brand glass cleaner solution evaporated from the antimicrobial film. Thus, by adding the indicator dye solution to the film-forming composition prior to forming the antimicrobial film, the presence of the antimicrobial film could be verified by applying an appropriate trigger composition to the antimicrobial film to reactivate the dye.

### Example 3

### Textured Wipe Versus Untextured Wipe

The effectiveness in removing a polymer film with a textured wipe versus an untextured wipe was evaluated. The textured wipe used was a scrubby wipe, and the untextured wipe used was a non-woven rayon/polyester blend wipe (3M™ SCOTCH-BRITE™ Disinfecting Wipe, available from 3M Company, St. Paul, Minn.).

Four polymers were tested—Carbowax 8000, Celvol 203S, Luviskol VA64 W, and Acumer 1000. Polymer solutions were made with 4% actives in DI water with 10% isopropyl alcohol. 0.2% Orcabrite Blue was dispersed in ready-made solutions with a Misonex Sonicator (available from Misonex Co., Farmingdale, N.Y.). Polymer coatings were made with a #18 draw down bar (commercially available from R.D. Specialties, Webster, N.Y.) on a glass slide and were dried at 300° F. (149° C.) for 5 minutes and allowed to cool. The wipe was prewet with 0.5 g/cm² of Neutral Cleaner solution and wrapped around a 3M™ SCOTCH-BRITE™ #96 hand pad and wiped across the coated glass slide once with a 1000 g weight applied. Table 4 lists the percent of polymer film removal after 1 pass with each wipe and lists a relative water solubility of the polymer films tested. The percent removal of the polymer film was determined by visual observation.

TABLE 4

| | % Removal after 1 pass | | |
|---|---|---|---|
| | Textured | Untextured | |
| Polymer | Wipe | Wipe | Relative Water Solubility |
| Carbowax 8000 | 100 | 100 | 1 - Most Soluble |
| Celvol 203S | 100 | 20 | 5 - Least Soluble |
| Luviskol VA64 W | 100 | 50 | 4 |
| Acumer 1000 | 100 | 80 | 2 |

### Example 4

### Aesthetic Properties of PVOH and PHMB

### Leveling Properties of Polyvinyl Alcohol

The ability of a polyvinyl alcohol coating to level out was evaluated and used to approximate the range of appropriate polymer concentrations to achieve a film-forming composition with good aesthetic properties.

The following Leveling Test was used:

A 2 mL quantity of test solution was applied and spread over half of a black vinyl tile. Immediately after spreading the test solution, an “X” was placed in the wet solution by drawing an applicator diagonally corner to corner. The same procedure was used on the other half of the tile with a control solution. The control solution was Stance. After drying, leveling was rated using the rating scale detailed in Table 5.

TABLE 5

| Rating | Criteria |
|---|---|
| Excellent | No “X” perceptible |
| Very Good | Faint outline of “X”, no ridges in film |
| Good | Plain outline of “X”, no ridges in film |
| Fair/Poor | Plain outline of “X”, ridges visible in film |

A variety of polyvinyl alcohol solutions (in DI water) having varying concentrations were coated onto a clear PET film (1 g of solution onto a 6″×8″ (0.15 m×0.20 m) section of a PET film) with surgical gauze. The reflectance of light in the polyvinyl alcohol films allowed the X to be seen, but the leveling quality was excellent in several cases. Table 6 lists the leveling test results for the various polyvinyl alcohol concentrations that were tested. A leveling rating was given for each polyvinyl alcohol solution, as compared to the control which was rated as Very Good.

TABLE 6

| Wt % PVOH-403 in water | Rating |
|---|---|
| 1 | Excellent |
| 2 | Very Good |
| 3 | Very Good |
| 4 | Very Good |
| 6 | Very Good |
| 8 | Good |
| 10 | Good |
| 12 | Poor |
| 15 | Poor |

### Aesthetic Properties of PHMB

The aesthetic properties of Vantocil P coated onto a PET film were evaluated and used to approximate the range of appropriate PHMB concentrations to achieve a film-forming composition with good aesthetic properties.

A 20% Vantocil P solution in DI water was wiped onto a PET film using surgical gauze. The 20% Vantocil P solution left a haze on the PET film after drying. A 15% Vantocil P solution in DI water was wiped onto a PET film in the same manner. The 15% Vantocil P solution left a slight haze on the PET film after drying, but was better than the 20% Vantocil P. A 10% Vantocil P solution in DI water was wiped onto a PET film in the same manner. Besides poor wetting, the 10% Vantocil P dried clear and tack free on the PET film.

### Example 5

### Water-Solubility of Polyvinyl Alcohol

### Film-Forming Composition Preparation

Solutions of polyvinyl alcohol and 5,000 ppm polyhexamethylene biguanide were prepared by the following procedure. Various amounts of the polyvinyl alcohol powders listed in Table 7 were dissolved in DI water and heated to 185° F. (85° C.) until a homogeneous mixture was achieved to form polymer solutions having the various weight percents of polyvinyl alcohol listed in Table 7. 0.1% by weight of Orcabrite Blue was added to each polymer dispersion. Then, a 20% stock solution of polyhexamethylene biguanide solution (Vantocil P) was combined with the polymer solutions to provide film-forming compositions having 5,000 ppm (0.5%) of polyhexamethylene biguanide.

### Antimicrobial Film Preparation

Glass slides were slowly dipped into each polyhexamethylene biguanide/polyvinyl alcohol film-forming composition and removed immediately. The glass slides were hung to dry for three days before solubility testing, such that an antimicrobial film corresponding to each film-forming composition was formed on a glass slide.

### Water-Solubility Test Method

140 mL of distilled water was poured into a 250 mL glass beaker. A 1″ (0.03 m) magnetic stir bar and a magnetic stirrer were used to agitate the water at 2000 rpm. The slides comprising the antimicrobial films were each immersed in a beaker of water without touching the sides of the beaker or the stir bar. The slides were each held securely while the water was agitated for 30 seconds. The slides were removed from the water and allowed to air dry in a vertical position. The slides were evaluated by visually observing the amount of blue dye remaining on the slides. Table 7 lists the estimated percent of antimicrobial film removed from glass slide for each concentration of polyvinyl alcohol.

TABLE 7

| | | Wt % PVOH | | |
|---|---|---|---|---|
| | | in dry | | |
| | Wt % PVOH | antimicrobial | PVOH:PHMB | |
| | in | film | wt ratio | % removed |
| PVOH | water | (calculated) | (calculated) | from slide |
| PVOH-403 | 1 | 67 | 2:1 | 100 |
| | 6 | 92 | 12:1 | 90 |
| | 12 | 96 | 24:1 | 70 |
| PVOH-26-88 | 1 | 67 | 2:1 | 80 |
| | 6 | 92 | 12:1 | 50 |
| | 12 | 96 | 24:1 | 20 |

### Example 6

### Biocidal Activity of 95:5 PVOH:PHMB

A total of 10 mL of a PVOH-2k:PHMB film-forming composition was prepared by adding 0.5 parts of PHMB to a solution of 9.5 parts of PVOH-2k, dissolved in 90 parts of DI water. That is, the film-forming composition had a total percent solids of 10%, comprised 9.5% PVOH, 0.5% PHMB and 90% DI water, and the resulting antimicrobial film had a calculated weight percent of PVOH of 95%, a calculated weight percent of PHMB of 5%, and a calculated weight ratio of PVOH:PHMB of 19:1.

The resulting film-forming composition was then coated onto a PET film using a #9 coating rod (commercially available from R.D. Specialties, Webster, N.Y.), and dried over night at room temperature (i.e., approximately 25° C.) to form an antimicrobial film.

The antimicrobial film was tested for “microbial load reduction” pursuant to the ASTM E2180-01 procedure described above for Example 1. Table 8 provides the microbial load reduction results for the antimicrobial film.

TABLE 8

| | % reduction of S. aureus | % reduction of P. aeruginosa |
|---|---|---|
| Sample | (gram positive) | (gram negative) |
| Composition 3 | 100 | 100 |

### Example 7

### Biocidal Activity of 95:5 PVP:PHMB

A total of 10 mL of a PVP:PHMB film-forming composition was prepared by adding 0.5 parts of PHMB to a solution of 9.5 parts of PVP, dissolved in 90 parts of DI water. That is, the film-forming composition had a total percent solids of 10%, comprised 9.5% PVP, 0.5% PHMB and 90% DI water, and the resulting antimicrobial film had a calculated weight percent of PVP of 95%, a calculated weight percent of PHMB of 5%, and a calculated weight ratio of PVP:PHMB of 19:1.

The resulting film-forming composition was then coated onto a PET film using a #9 coating rod (commercially available from R.D. Specialties, Webster, N.Y.), and dried over night at room temperature (i.e., approximately 25° C.) to form an antimicrobial film.

The antimicrobial film was tested for “microbial load reduction” pursuant to the ASTM E2180-01 procedure described above for Example 1. Table 9 provides the microbial load reduction results for the antimicrobial film.

TABLE 9

| | % reduction of | % reduction of |
|---|---|---|
| | S. aureus | P. aeruginosa |
| Sample | (gram positive) | (gram negative) |
| Comparative Composition C | 92 | 94 |

### Example 8

### Biocidal Activity for Coated PVOH:PHMB

Various amounts of PVOH were combined with various amounts of Vantocil 100, according to the PVOH:PHMB concentrations listed in Table 10. The “PVOH” used in this example consisted of a 50:50 blend containing PVOH-403 and PVOH-26-88. With reference to Table 10, Composition 5, for example, included a 9.5% PVOH film-forming composition, a total of 10 mL was prepared by adding 0.5 parts of PHMB to a solution of 9.5 parts of PVOH, dissolved in 90 parts of DI water. That is, Composition 5 had a total percent solids of 10%, comprised 9.5% PVOH, 0.5% PHMB and 90% DI water, and the resulting antimicrobial film had a calculated weight percent of PVOH of 95%, a calculated weight percent of PHMB of 5%, and a calculated weight ratio of PVOH:PHMB of 19:1. The other formulations listed in Table 10 were prepared to the concentrations specified in Table 10 following a similar procedure (i.e., a total of 10 mL of each film-forming composition was formed comprising a total percent solids of 10%). The columns headed “Wt % PVOH in the dry antimicrobial film” and “PVOH:PHMB wt ratio” contain calculated values.

The resulting film-forming compositions were then coated onto PET films using a #9 coating rod (commercially available from R.D. Specialties, Webster, N.Y.), and dried over night at room temperature (i.e., approximately 25° C.) to form antimicrobial films.

Each antimicrobial film was tested for “microbial load reduction” pursuant to the ASTM E2180-01 procedure described above for Example 1. Table 10 provides the microbial load reduction results for each coated antimicrobial film.

TABLE 10

| | Wt % | Wt % | Wt % | | | |
|---|---|---|---|---|---|---|
| | PVOH in | PHMB in | PVOH in | | % reduction | % reduction |
| | film- | film- | dry anti- | | of S. aureus | of P. aeruginosa |
| | forming | forming | microbial | PVOH:PHMB | (gram | (gram |
| Sample | comp. | comp. | film | wt ratio | positive) | negative) |
| Composition 4 | 9.0 | 1.0 | 90 | 9:1 | 100 | 100 |
| Composition 5 | 9.5 | 0.5 | 95 | 19:1 | 100 | 100 |
| Composition 6 | 9.7 | 0.3 | 97 | 32:1 | 100 | 100 |
| Composition 7 | 9.9 | 0.1 | 99 | 99:1 | 100 | 100 |

### Example 9

### Biocidal Activity for Wiped PVOH:PHMB

Various amounts of PVOH were combined with various amounts of Vantocil 100, according to the PVOH:PHMB concentrations listed in Table 11. The “PVOH” used in this example consisted of a 50:50 blend containing PVOH-403 and PVOH-26-88. With reference to Table 11, Composition 8, for example, included 9.7% PVOH film-forming composition, a total of 50 mL was prepared by adding 1.5 parts of PHMB to a solution of 48.5 parts of PVOH, dissolved in 450 parts of DI water. That is, Composition 8 had a total percent solids of 10%, comprised 9.7% PVOH, 0.3% PHMB and 90% DI water, and the resulting antimicrobial film had a calculated weight percent of PVOH of 97%, a calculated weight percent of PHMB of 3%, and a calculated weight ratio of PVOH:PHMB of 32:1. The other formulations listed in Table 11 were prepared to the concentrations specified in Table 11 following a similar procedure (i.e., a total of 50 mL of each film-forming composition was formed comprising a total percent solids of 10%). The columns headed “Wt % PVOH in the dry antimicrobial film” and “PVOH:PHMB wt ratio” contain calculated values.

The resulting film-forming compositions were wiped onto a PET film according to the following procedure. A WypAll L30 paper towel (available from Kimberly-Clark Professional, Roswell, Ga.) was folded in half two times (so that it was a square, one quarter of the paper towel's original size). The paper towel was then sprayed 5 times (4 corner sprays and 1 center spray) with the film-forming compositions, keeping the distance and pressure as constant as possible. The wipe was then wiped in a zigzag motion for 5 full (i.e., back and forth) cycles on a PET film and allowed to air-dry for 1 hour at room temperature to form an antimicrobial film.

Each antimicrobial film was tested for “microbial load reduction” pursuant to the ASTM E2180-01 procedure described above for Example 1. Table 11 provides the microbial load reduction results for each wiped antimicrobial film. The wiped antimicrobial films of Compositions 8 and 9 were not effectively biocidal, which indicates that the loading rate of the wipe (i.e., the paper towel) needs to be increased, which can be done by either increasing the volume of the film-forming composition that is loaded into the wipe, or by increasing the concentration of antimicrobial agent in the film-forming composition that is loaded into the wipe.

TABLE 11

| | Wt % | Wt % | Wt % | | | |
|---|---|---|---|---|---|---|
| | PVOH in | PHMB in | PVOH in | | % reduction | % reduction |
| | film- | film- | dry anti- | | of S. aureus | of P. aeruginosa |
| | forming | forming | microbial | PVOH:PHMB | (gram | (gram |
| Sample | comp. | comp. | film | wt ratio | positive) | negative) |
| Composition 8 | 9.7 | 0.3 | 97 | 32:1 | 82.9 | 98.9 |
| Composition 9 | 9.9 | 0.1 | 99 | 99:1 | 8.2 | 63.3 |

### Example 10

### ATR-FTIR Spectra for PVOH:PHMB and PVP:PHMB

Ten milliliters (mL) of a comparative film-forming composition (PVP:PHMB) comprising PVP-K90 (PVP) and Vantocil 100 (PHMB) was formed by adding 0.2 parts of PHMB to a solution of 9.8 parts of PVP, dissolved in 90 parts of DI water.

Ten milliliters (mL) of a film-forming composition (PVOH:PHMB) comprising PVOH (i.e., a 50:50 blend of PVOH-403:PVOH-26-88) and Vantocil 100 (PHMB) was formed by adding 0.2 parts of PHMB to a solution of 9.8 parts of the PVOH, dissolved in 90 parts of DI water.

A solution of neat Vantocil 100 (PHMB) (“Neat Vantocil”) was prepared by adding 1 part Vantocil 100 to 9 parts of DI water. The neat PVOH-blend (“Neat PVOH”) and the neat PVP (“Neat PVP”) solutions were made by adding 3 parts of polymer binder to 97 parts of DI water.

A first Attenuated Total Reflection Fourier Transformed Infrared Spectroscopy (ATR-FTIR) spectrum was acquired for the PVP-K90 alone (“Neat PVP”), the Vantocil 100 alone (“Neat Vantocil”) and the comparative film-forming composition described above (“Vantocil & PVP”), and is shown in FIG. 2A.

A second Attenuated Total Reflection, Fourier Transformed Infrared Spectroscopy (ATR-FTIR) spectrum was obtained for the PVOH-blend alone (“Neat PVOH”), the Vantocil 100 alone (“Neat Vantocil”) and the film-forming composition described above (“Vantocil & PVOH”), and is shown in FIG. 2B.

The ATR-FTIR spectra were obtained using a germanium crystal on a Nicolet NEXUS 670 ATR-FTIR spectroscopy instrument (available from Thermo Fisher Scientific, Inc., Waltham, Mass.) with the following data acquisition parameters: Number of sample scans: 32 (continuous mode); Number of background scans: 32; Resolution: 4.000 cm-1; Mirror velocity: 1.8988 cm/sec; Aperture: 32.00; Detector: MCT/A; and Beamsplitter: KBr.

From the ATR-FTIR spectrum shown in FIG. 2A, and not wishing to be bound by theory, it appears that there is some interaction between the PVP-K90 and the Vantocil 100 (i.e., there is a peak shift of the PVP-K90 when it is combined with the Vantocil 100). Knowing that PVP-K90 has an overall slight negative charge and that Vantocil 100 has an overall slight positive charge, one possible explanation may be that there is a Coulomb attraction or ionic interaction between the PVP-K90 and the Vantocil 100. Such an interaction between the polymer and the antimicrobial agent could limit the availability of the antimicrobial agent for biocidal activity, thereby increasing the amount of antimicrobial agent needed to achieve at least 99%, and at least 99.9%, microbial load reductions for gram positive and gram negative bacteria.

On the contrary, from the ATR-FTIR spectrum shown in FIG. 2B, and not wishing to be bound by theory, it appears that no such complex or interaction is formed between the PVOH-403 and the Vantocil 100 (i.e., there is no peak shift of the PVOH-403 when it is combined with the Vantocil 100). If the polymer and antimicrobial agent do not form any significant complexation or interaction, the antimicrobial agent should be more available for biocidal activity. Examples 6, 7 and 11 appear to support this theory.

### Example 11

### Biocidal Activity of Sulfonated Polyurethane:PHMB and PVP:PHMB

The following Comparative Compositions D and E were prepared according to the following procedure. The polymers were diluted or dissolved in DI water to make up a stock 10% solids dispersion. The Vantocil P was used as a 20% stock solution in DI water (i.e., 20% aqueous solution of Vantocil 100). The comparative film-forming compositions were formed by combining the polymer dispersion, the Vantocil P dispersion, isopropyl alcohol and dioctylsulfosuccinate in the amounts shown in Table 12.

TABLE 12

| | Comparative | Comparative |
|---|---|---|
| | Composition D | Composition E |
| | wt % | wt % |
| Sulfonated PUD | 29.8 | — |
| PVP-K30 | — | 8.95 |
| Vantocil 100 (20% in DI | 25 | 25 |
| water) | | |
| Water | 35.2 | 56.05 |
| Isopropyl alcohol | 9.5 | 9.5 |
| dioctylsulfosuccinate | 0.5 | 0.5 |

The comparative film-forming compositions were coated onto a PET film using a wire-wrapped Meier rod #32, which formed a 1.4 mil wet film. The films were dried in a forced air Despatch LFD Series oven (available from Despatch Corp., Minneapolis, Minn.) at 100° F. (38° C.).

Each antimicrobial film was tested for “microbial load reduction” pursuant to the ASTM E2180-01 procedure described above for Example 1. Table 13 provides the microbial load reduction results for each wiped antimicrobial film. The high level of kill was largely due to the very large concentration of PHMB in the dry film composition as compared to inventive examples.

TABLE 13

| | | Polymer:PHMB | % reduction | % reduction |
|---|---|---|---|---|
| | wt % polymer | (wt ratio in dry | of | of |
| | in dry anti- | anti-microbial | S. aureus | P. aeruginosa |
| Sample | microbial film | film) | (gram positive) | (gram negative) |
| Comparative Composition D | 64 | 1.8:1 | 100 | 100 |
| Comparative Composition E | 64 | 1.8:1 | 100 | 100 |

### Example 12

### Biocidal Activity for Coated PVOH:PHMB, PVOH:QUAT, and PVOH:PHMB+QUAT

Compositions 10-15 were formed of various amounts of PVOH, Vantocil 100 (PHMB), and/or CarboShield (QUAT), according to the concentrations listed in Table 14. The “PVOH” used in this example consisted of a 50:50 blend containing PVOH-403 and PVOH-26-88. A 10% stock solution of PVOH was prepared, and appropriate amounts added to Compositions 10-15 such that each composition contained 3% PVOH. The weight percent of PVOH in the resulting antimicrobial film and the weight ratio of PVOH to antimicrobial(s) for each of Compositions 10-15 were calculated and are reported in Table 14. For example, with reference to Table 14, the antimicrobial film formed from Composition 10 had a calculated weight percent of PVOH of 86% (and a calculated weight percent of PHMB of 14%), and a calculated weight ratio of PVOH:PHMB of 6:1. The columns headed “Wt % PVOH in the dry antimicrobial film” and “PVOH:Antimicrobial wt ratio” contain calculated values.

Compositions 10-12, along with a PVOH control film-forming composition (designated in Table 14 as “PVOH Control I”), were coated onto PET films using a #9 coating rod (commercially available from R.D. Specialties, Webster, N.Y.), and dried over night at room temperature (i.e., approximately 25° C.) to form antimicrobial films.

In addition, Compositions 13-15 each included 0.05% of Glucopon. Compositions 13-15, along with a PVOH control film-forming composition (designated in Table 14 as “PVOH Control II”) were coated onto PET films using a #9 coating rod (commercially available from R.D. Specialties, Webster, N.Y.), and dried over night at room temperature (i.e., approximately 25° C.) to form antimicrobial films.

Each antimicrobial film was tested for “microbial load reduction” pursuant to the ASTM E2180-01 procedure described above for Example 1. The bacterial counts (CFU/cm²) results for PVOH Control I and II are reported in Table 15, and the microbial load reduction results for Compositions 10-15 are reported in Table 16 as percentages.

TABLE 14

| | | | Wt % | Wt % | Wt % | | | |
|---|---|---|---|---|---|---|---|---|
| | | | PVOH | PHMB | QUAT | | | |
| | | | in film- | in film- | in film- | | Wt % PVOH | PVOH:Anti- |
| | Anti- | | forming | forming | forming | Total % | in dry anti- | microbial |
| Sample | micr. | Surf. | comp. | comp. | comp. | Solids | microbial film | wt ratio |
| PVOH | None | None | 3 | — | — | 3 | 100 | 1:0 |
| Control I | | | | | | | | |
| Composition | PHMB | None | 3 | 0.5 | — | 3.5 | 86 | 6:1 |
| 10 | | | | | | | | |
| Composition | QUAT | None | 3 | — | 0.5 | 3.5 | 86 | 6:1 |
| 11 | | | | | | | | |
| Composition | PHMB + | None | 3 | 0.5 | 0.5 | 4.0 | 75 | 6:1:1 |
| 12 | QUAT | | | | | | | |
| PVOH | None | None | 3 | — | — | 3 | 100 | 1:0 |
| Control II | | | | | | | | |
| Composition | PHMB | 0.05% | 3 | 0.5 | — | 3.55 | 85 | 6:1 |
| 13 | | Glucopon | | | | | | |
| Composition | QUAT | 0.05% | 3 | — | 0.5 | 3.55 | 85 | 6:1 |
| 14 | | Glucopon | | | | | | |
| Composition | PHMB + | 0.05% | 3 | 0.5 | 0.5 | 4.05 | 74 | 6:1:1 |
| 15 | QUAT | Glucopon | | | | | | |

TABLE 15

| | | | % reduction | % reduction of |
|---|---|---|---|---|
| | | | of S. aureus | P. aeruginosa |
| | Anti- | | (gram | (gram |
| Sample | microbial | Surfactant | positive) | negative) |
| PVOH Control I | None | None | 5.27 × 10⁴ | 6.47 × 10⁴ |
| PVOH Control | None | None | 5.27 × 10⁴ | 5.27 × 10⁴ |
| II | | | | |

TABLE 16

| | | | % reduction | % reduction of |
|---|---|---|---|---|
| | | | of S. aureus | P. aeruginosa |
| | | | (gram | (gram |
| Sample | Anti-microbial | Surfactant | positive) | negative) |
| Composition | PHMB | None | 100 | 100 |
| 10 | | | | |
| Composition | QUAT | None | 100 | 100 |
| 11 | | | | |
| Composition | PHMB + | None | 100 | 100 |
| 12 | QUAT | | | |
| Composition | PHMB | 0.05% | 100 | 100 |
| 13 | | Glucopon | | |
| Composition | QUAT | 0.05% | 100 | 100 |
| 14 | | Glucopon | | |
| Composition | PHMB + | 0.05% | 100 | 100 |
| 15 | QUAT | Glucopon | | |

### Example 13

### Biocidal Activity for Coated and Wiped PVOH:PHMB+QUAT

Compositions 16-27 were formed of various amounts of PVOH, Vantocil 100 (PHMB), CarboShield (QUAT), and/or 0.05% Glucopon, according to the concentrations listed in Table 17. The “PVOH” used in this example consisted of a 50:50 blend containing PVOH-403 and PVOH-26-88. A 10% stock solution of PVOH was prepared, and appropriate amounts added to Compositions 16-27 such that each composition contained 3% PVOH. The weight percent of PVOH in the resulting antimicrobial film and the weight ratio of PVOH to antimicrobial(s) for each of Compositions 16-27 were calculated and are reported in Table 17. For example, with reference to Table 17, the antimicrobial film formed from Composition 16 had a calculated weight percent of PVOH of 94%, and a calculated weight ratio of PVOH:PHMB:QUAT of 30:1:1. The columns headed “Wt % PVOH in the dry antimicrobial film” and “PVOH:Antimicrobial(s) wt ratio(s)” contain calculated values.

The resulting film-forming compositions for Compositions 16-21 were coated onto PET films using a #9 coating rod (commercially available from R.D. Specialties, Webster, N.Y.), and dried over night at room temperature (i.e., approximately 25° C.) to form antimicrobial films, and are designated as “C” in Table 17 and “Coated” in Table 18.

The resulting film-forming compositions for Compositions 22-27 were wiped onto a PET film according to the following procedure, and are designated as “W” in Table 17 and “Wiped” in Table 18. A WypAll L30 paper towel (available from Kimberly-Clark Professional, Roswell, Ga.) was folded in half two times (so that it was a square, one quarter of the paper towel's original size). The paper towel was then sprayed 5 times (4 corner sprays and 1 center spray) with the film-forming compositions, keeping the distance and pressure as constant as possible. The wipe was then wiped in a zigzag motion for 5 full (i.e., back and forth) cycles on a PET film and allowed to air-dry for 1 hour at room temperature to form an antimicrobial film.

Each antimicrobial film, whether it was coated or wiped, was tested for “microbial load reduction” pursuant to the ASTM E2180-01 procedure described above for Example 1. Table 18 provides the microbial load reduction results for each coated and wiped antimicrobial film.

TABLE 17

| | | | | Wt % | Wt % | Wt % | | | |
|---|---|---|---|---|---|---|---|---|---|
| | | | | PVOH | PHMB | QUAT | | Wt % | |
| | | | | in | in | in | | PVOH in | |
| | | | | film- | film- | film- | | dry anti- | PVOH:Anti- |
| | | | | forming | forming | forming | Total % | microbial | microbial(s) |
| Sample | Anti-micr. | Surf. | C/W | comp. | comp. | comp. | Solid | film | wt ratio(s) |
| Composition | PHMB + | None | C | 3 | 0.1 | 0.1 | 3.2 | 94 | 30:1:1 |
| 16 | QUAT | | | | | | | | |
| Composition | PHMB + | None | C | 3 | 0.2 | 0.2 | 3.4 | 88 | 15:1:1 |
| 17 | QUAT | | | | | | | | |
| Composition | PHMB + | None | C | 3 | 0.3 | 0.3 | 3.6 | 83 | 10:1:1 |
| 18 | QUAT | | | | | | | | |
| Composition | PHMB + | None | C | 3 | 0.4 | 0.4 | 3.8 | 79 | 7.5:1:1 |
| 19 | QUAT | | | | | | | | |
| Composition | PHMB + | None | C | 3 | 0.5 | 0.5 | 4 | 75 | 6:1:1 |
| 20 | QUAT | | | | | | | | |
| Composition | PHMB + | 0.05% | C | 3 | 0.3 | 0.3 | 3.65 | 82 | 10:1:1 |
| 21 | QUAT | Glucopon | | | | | | | |
| Composition | PHMB + | None | W | 3 | 0.1 | 0.1 | 3.2 | 94 | 30:1:1 |
| 22 | QUAT | | | | | | | | |
| Composition | PHMB + | None | W | 3 | 0.2 | 0.2 | 3.4 | 88 | 15:1:1 |
| 23 | QUAT | | | | | | | | |
| Composition | PHMB + | None | W | 3 | 0.3 | 0.3 | 3.6 | 83 | 10:1:1 |
| 24 | QUAT | | | | | | | | |
| Composition | PHMB + | None | W | 3 | 0.4 | 0.4 | 3.8 | 79 | 7.5:1:1 |
| 25 | QUAT | | | | | | | | |
| Composition | PHMB + | None | W | 3 | 0.5 | 0.5 | 4 | 75 | 6:1:1 |
| 26 | QUAT | | | | | | | | |
| Composition | PHMB + | 0.05% | W | 3 | 0.3 | 0.3 | 3.65 | 82 | 10:1:1 |
| 27 | QUAT | Glucopon | | | | | | | |

TABLE 18

| | | | % reduction | % reduction of |
|---|---|---|---|---|
| | | | of S. aureus | P. aeruginosa |
| | Anti- | | (gram | (gram |
| Sample | microbial | Coated/Wiped | positive) | negative) |
| Composition | PHMB + | Coated | 100 | 100 |
| 16 | QUAT | | | |
| Composition | PHMB + | Coated | 100 | 100 |
| 17 | QUAT | | | |
| Composition | PHMB + | Coated | 100 | 100 |
| 18 | QUAT | | | |
| Composition | PHMB + | Coated | 100 | 100 |
| 19 | QUAT | | | |
| Composition | PHMB + | Coated | 100 | 100 |
| 20 | QUAT | | | |
| Composition | PHMB + | Coated | 100 | 100 |
| 21 | QUAT | | | |
| Composition | PHMB + | Wiped | 100 | 100 |
| 22 | QUAT | | | |
| Composition | PHMB + | Wiped | 100 | 100 |
| 23 | QUAT | | | |
| Composition | PHMB + | Wiped | 100 | 100 |
| 24 | QUAT | | | |
| Composition | PHMB + | Wiped | 100 | 100 |
| 25 | QUAT | | | |
| Composition | PHMB + | Wiped | 100 | 100 |
| 26 | QUAT | | | |
| Composition | PHMB + | Wiped | 100 | 100 |
| 27 | QUAT | | | |

### Example 14

### AOAC Disinfectant Test for PVOH:PHMB+QUAT

A film-forming composition was prepared in DI water of 3% PVOH, 0.3% Vantocil 100 (PHMB), 0.3% CarboShield (QUAT), and 0.05% Glucopon. The “PVOH” used in this example consisted of a 50:50 blend containing PVOH-403 and PVOH-26-88. A 10% stock solution of PVOH was prepared, and the appropriate amount added such that the film-forming composition contained 3% PVOH. As a result, the film-forming composition had a total percent solids of 3.65%, and the resulting antimicrobial film had a calculated weight percent of PVOH of about 82%, a calculated weight percent of PHMB of about 8%, a calculated weight percent of QUAT of about 8%, and a calculated weight ratio of PVOH:PHMB:QUAT of about 10:1:1.

The efficacy of this film-forming composition as a disinfectant against Pseudomonas aeruginosa on hard surfaces was then tested according to the following Association of Analytical Communities (AOAC) International Use-Dilution Test 964.02 (1990).

The AOAC International Use-Dilution Test is a carrier based test. The carriers used in this Example were uninoculated porcelain penicylinders, commercially available from Presque Isle Cultures, Erie, Pa. The carriers were inoculated with a test organism (i.e., P. aeruginosa), dried, exposed to the use-dilution of the disinfectant product (i.e., the above-described film-forming composition), and cultured to assess the survival of the bacteria. A single test involved the evaluation of ten inoculated carriers (one organism only) against one product (disinfectant) sample. In addition to the ten carriers, as required in the AOAC International Use-Dilution Test, six additional carriers (i e , uninoculated porcelain penicylinders from Presque Isle Cultures) were used to estimate the average bacterial load on the carriers (i.e., with varying dilution rates).

Three test cultures of the same organism are initiated in parallel from a stock culture and subcultured, resulting in solutions with a bacterial count of roughly 1×10⁸. The three cultures were very carefully pooled by decanting the individual subcultures, making sure that the pellicle floating at the top of the culture was not decanted. After vortexing and allowing the culture to sit for 10 minutes, 10 ml were pipetted into sterile 25 mm×150 mm test tubes. Then the carriers were aseptically transferred into the test tubes containing culture using a sterilized wire hook. The carriers were incubated for 20 minutes at 37° C. The carriers were removed from the bacterial solution and dried on Whatman No. 2 filter paper for 40 minutes at 37° C. In the meantime, 50% of the sterilized test tubes were loaded with 10 mL of disinfectant, 30% of the test tubes were loaded with 10 mL of 5000 ppm bleach solution, and the remaining 20% of test tubes were loaded with 10 mL of DI water.

After 40 minutes of dry time, the carriers were transferred into the test tubes containing the disinfectant, bleach solution, or DI water, respectively. After 5 minutes, the carriers were removed with a sterilized wire hook and transferred into 10-mL solutions of neutralizing broth (i.e., DE broth). After a dwell time of 30 minutes, the carriers were removed from the neutralizing broth using a sterilized wire hook and transferred into test tubes containing 10 mL of Letheen broth. After 24 hours, the individual test tubes were visually evaluated for bacterial growth.

Carriers that were inoculated but not challenged with disinfectant were individually transferred into a 10-mL solution of Letheen broth and subsequently vortexed. Using a serial dilution up to 1×10⁸, the diluted solutions were plated on 3M Petrifilm Plates (commercially available from 3M Company, St. Paul, Minn.), in order to obtain a more accurate understanding of how many bacteria were inoculated on the individual carriers used for the test procedure described above.

The film-forming composition passed the AOAC International Use-Dilution Test as there was no bacterial growth visually observable in the test tubes (i.e., clear solution, compared to the control with bacterial growth that turned the solution hazy/cloudy).

### Example 15

### Cleaning Test for PVOH:PHMB+QUAT

A film-forming composition, Composition 28, was prepared in DI water of 3% PVOH, 0.4% Vantocil 100 (PHMB), 0.1% CarboShield (QUAT), and 0.05% Glucopon. The “PVOH” used in this example consisted of a 50:50 blend containing PVOH-403 and PVOH-26-88. A 10% stock solution of PVOH was prepared, and the appropriate amount added such that the film-forming composition contained 3% PVOH. As a result, the film-forming composition had a total percent solids of 3.55%, and the resulting antimicrobial film formed from Composition 28 had a calculated weight percent of PVOH of about 85%, a calculated weight percent of PHMB of about 11%, a calculated weight percent of QUAT of about 3%, and a calculated weight ratio of PVOH:PHMB:QUAT of about 28:4:1.

The cleaning efficacy of this film-forming composition (Composition 28 in Table 19) was compared to other cleaning compositions and D.I. water, according to ASTM D5343-06, and the results are provided in Table 19. The cleaning results of each cleaning composition and the D.I. water were determined according to the rating scale in ASTM D5343-06, which is reproduced below in Table 20.

TABLE 19

| Sample | Description | Results |
|---|---|---|
| Comparative Composition | 3M Cleaner | 5 |
| F | | |
| Comparative Composition | 3M Mark Remover | 4 |
| G | | |
| Comparative Composition | D.I. Water | 2 |
| H | | |
| Composition 28 | PVOH: PHMB: QUAT: Glucopon | 5 |

TABLE 20
Rating Scale for ASTM D5343-06

| | |
|---|---|
| 1 | No or very little soil removed |
| 2 | Approximately 25% of soil removed |
| 3 | Approximately 50% of soil removed |
| 4 | Approximately 75% of soil removed |
| 5 | Virtually all soil removed |

### Example 16

### Biocidal Activity for Coated PVOH:PHMB, PVOH:QUAT, and PVOH:PHMB+QUAT at Various Timepoints

Compositions 29-31 were formed of various amounts of PVOH, Vantocil 100 (PHMB), CarboShield (QUAT), and/or 0.05% Glucopon, according to the concentrations listed in Table 21. The “PVOH” used in this example consisted of a 50:50 blend containing PVOH-403 and PVOH-26-88. A 10% stock solution of PVOH was prepared, and appropriate amounts added to Compositions 29-31 such that each composition contained 3% PVOH. The weight percent of PVOH in the resulting antimicrobial film and the weight ratio of PVOH to antimicrobial(s) for each of Compositions 29-31 were calculated and are reported in Table 21. For example, with reference to Table 21, the antimicrobial film formed from Composition 29 had a calculated weight percent of PVOH of 86%, and a calculated weight ratio of PVOH:PHMB of 6:1. The columns headed “Wt % PVOH in the dry antimicrobial film” and “PVOH:Antimicrobial(s) wt ratio(s)” contain calculated values.

The resulting film-forming compositions, along with a PVOH control film-forming composition (designated in Table 18 as “PVOH Control”), were then coated onto PET films using a #9 coating rod (commercially available from R.D. Specialties, Webster, N.Y.), and dried over night at room temperature (i.e., approximately 25° C.) to form antimicrobial films.

The following test protocol, adapted from JIS Z 2801:2000 (Japanese Industrial Standard—Test for Antimicrobial Activity; published in 2000), was used to assess the antimicrobial properties (i.e., the “microbial load reduction”) of each antimicrobial film on polyethylene terepthalate (PET) films at various timepoints.

### Day 1

1. Started overnight growth cultures at 37° C., 250 RPM for P. aeruginosa (ATCC #9027) and S. aureus (ATCC #6538) via stem-loop inoculation from freshly-streaked agar plates (i.e., less than two weeks old) into a sterile culture tube containing 10 mL of Trypticase Soy Broth (VWR #90000-378). Allowed to grow for 18-24 hours before use.
2. Prepared 500 mL of D/E Neutralizing Broth (VWR cat #90004-038) according to bottle and autoclaved at 121° C. for 15 min. (used as an alternative to SCDLP broth, defined in JIS Z 2801 protocol).
3. Prepared and autoclaved 2 bottles containing 100 mL of 0.2% TSB in distilled, deionized water at 121° C. for 15 minutes. Also, prepared 1000 mL of phosphate buffered solution (PBS): 0.24 g KH₂PO₄, 1.44 g Na₂HPO₄, 8 g NaCl, 1L DDH₂O, adjusted pH to 7.0, autoclaved 20 min. at 121° C.

### Day 2

4. For each timepoint, four 4×4 cm pieces of each test material and polyethylene terepthalate (PET) control (3-4 mil thickness) were cut out. Two of the four pieces from each material were inoculated with S. aureus, and the other two with P. aeruginosa, labeled accordingly.
5. The materials were placed into sterile Petri dishes labeled for the material, the replicate number and the organism.
6. 2×2 cm pieces of covering film (PET, 3-4 mil thick) were cut out for each 4×4 cm piece of test material, and were set aside. Cover slips were sterilized by wiping with isopropanol or 70% ethanol, and allowed to dry. Cover slips were used to increase the surface area contact between the material and the inoculum by sandwiching the inoculum between a cover slip and the material surface.
7. One of the bottles of sterile 100 mL 0.2% TSB was labeled for S. aureus, and 20 μL of the overnight culture of S. aureus were transferred into the medium for a final suspension of about 10⁶ cells/mL. This was repeated for the other bottle using P. aeruginosa.
8. 500 μL of the cell suspension were pipetted onto the surface of the material in the corresponding Petri dishes. The covering film was placed over inoculum.
9. The inoculated material was placed into an environment-controlled incubator at 37° C., 70-80% relative humidity for each of the time periods reported in Tables 23 and 24.
10. Using flame-sterilized tweezers, the inoculated material was removed from the Petri dish and carefully placed into a labeled 50 mL Falcon tube containing 10 mL of sterile D/E Neutralizing broth, and then placed in an ultrasonic bath for 1 min. Samples were removed from the ultrasonic bath, and vortexed for 1 min (used in place of the stomacher referenced in the JIS Z 2801 protocol).
11. Serial dilutions were made of the harvesting medium by transferring 1 mL into 9 mL of PBS, and the dilutions were plated accordingly and incubated overnight.

### Day 3

12. The colony forming units (CFU's) were counted for each 1-mL sample, and the duplicate samples were averaged. The log reduction was calculated, based on the CFU count at timepoint zero.

The bacterial counts (reported in CFU/sample) for each of S. aureus and P. aeruginosa were the same for each composition and the PVOH Control at timepoint zero. The bacterial counts of both S. aureus and P. aeruginosa for the PVOH Control are reported in Table 22. Table 23 provides the microbial load reduction results for S. aureus (gram positive) for each coated antimicrobial film at each timepoint, and Table 24 provides the microbial load reduction results for P. aeruginosa (gram negative) for each coated antimicrobial film at each timepoint.

TABLE 21

| | | Wt % | Wt % | Wt % | | | |
|---|---|---|---|---|---|---|---|
| | | PVOH | PHMB | QUAT | | Wt % | |
| | | in | in | in | | PVOH in | |
| | | film- | film- | film- | | dry anti- | PVOH:Anti- |
| | Anti- | forming | forming | forming | Total % | microbial | microbial(s) |
| Sample | microbial | comp. | comp. | comp. | Solids | film | wt ratio(s) |
| PVOH | None | 3 | — | — | 3 | 100 | 1:0 |
| Control | | | | | | | |
| Composition | PHMB | 3 | 0.5 | — | 3.5 | 86 | 6:1 |
| 29 | | | | | | | |
| Composition | QUAT | 3 | — | 0.5 | 3.5 | 86 | 6:1 |
| 30 | | | | | | | |
| Composition | PHMB + | 3 | 0.5 | 0.5 | 4.0 | 75 | 6:1:1 |
| 31 | QUAT | | | | | | |

TABLE 22
Bacterial counts (CFU/sample) of S. aureus and
P. aeruginosa for PVOH Control

| Sample | 0 hrs. | 0.167 hrs. | 0.5 hrs. | 1 hr. | 4 hrs. | 8 hrs. | 24 hrs. |
|---|---|---|---|---|---|---|---|
| PVOH | 1.32 × 10⁵ | 1.48 × 10⁵ | 1.86 × 10⁵ | 2.70 × 10⁵ | 2.75 × 10⁶ | 3.05 × 10⁶ | 4.85 × 10⁶ |
| Control - | | | | | | | |
| S. aureus | | | | | | | |
| PVOH | 3.70 × 10⁵ | 2.30 × 10⁵ | 1.60 × 10⁵ | 1.65 × 10⁵ | 5.05 × 10⁶ | 6.35 × 10⁶ | 1.70 × 10⁷ |
| Control - | | | | | | | |
| P. aeruginosa | | | | | | | |

TABLE 23
Microbial load reduction results for S. aureus (gram positive)

| Sample | 0.167 hrs. | 0.5 hrs. | 1 hr. | 4 hrs. | 8 hrs. | 24 hrs. |
|---|---|---|---|---|---|---|
| Composition 29 | 100% | 100% | 100% | 100% | 100% | 100% |
| Composition 30 | 100% | 100% | 100% | 100% | 100% | 100% |
| Composition 31 | 100% | 100% | 100% | 100% | 100% | 100% |

TABLE 24
Microbial load reduction results for
P. aeruginosa (gram negative)

| Sample | 0.167 hrs. | 0.5 hrs. | 1 hr. | 4 hrs. | 8 hrs. | 24 hrs. |
|---|---|---|---|---|---|---|
| Composition 29 | 100% | 100% | 100% | 100% | 100% | 100% |
| Composition 30 | 100% | 100% | 100% | 100% | 100% | 100% |
| Composition 31 | 100% | 100% | 100% | 100% | 100% | 100% |

### Example 17

### Biocidal Activity for Coated PVOH:PHMB at Indirect Food Contact Limit

Composition 32 was formed of PVOH, and Vantocil 100 (PHMB), according to the concentrations listed in Table 25. The “PVOH” used in this example consisted of a 50:50 blend containing PVOH-403 and PVOH-26-88. A 10% stock solution of PVOH was prepared, and the appropriate amount added such that Composition 32 contained 4% PVOH. The weight percent of PVOH in the resulting antimicrobial film and the weight ratio of PVOH to antimicrobial(s) for Composition 32 were calculated and are reported in Table 25. The columns headed “Wt % PVOH in the dry antimicrobial film” and “PVOH:Antimicrobial(s) wt ratio(s)” contain calculated values.

The resulting film-forming composition was coated onto PET films using a #9 coating rod (commercially available from R.D. Specialties, Webster, N.Y.), and dried over night at room temperature (i.e., approximately 25° C.) to form antimicrobial films.

The antimicrobial film was tested for “microbial load reduction” pursuant to the ASTM E2180-01 procedure described above for Example 1. Table 25 provides the microbial load reduction results for the coated antimicrobial film.

TABLE 25

| | | Wt % | Wt % | | Wt % | | % | % |
|---|---|---|---|---|---|---|---|---|
| | | PVOH | PHMB | | PVOH in | | reduction | reduction |
| | | in film- | in film- | | dry anti- | PVOH:Anti- | of S. aureus | of P. aeruginosa |
| | Anti- | forming | forming | Total % | microbial | microbial(s) | (gram | (gram |
| Sample | micr. | comp. | comp. | Solids | film | wt ratio(s) | positive) | negative) |
| Composition 32 | PHMB | 4 | 0.054 | 4.054 | 99 | 74:1 | 99.90 | 99.70 |

### Example 18

### Fungal Challenge for Wet and Dry PVOH:PHMB+QUAT at Various Timepoints

Compositions 33-34 were formed of various amounts of PVOH, Vantocil 100 (PHMB), and/or CarboShield (QUAT), according to the concentrations listed in Table 26. The “PVOH” used in this example consisted of a 50:50 blend containing PVOH-403 and PVOH-26-88. A 10% stock solution of PVOH was prepared, and appropriate amounts added to Compositions 33-34 such that each composition contained 3% PVOH. The weight percent of PVOH in the resulting antimicrobial film and the weight ratio of PVOH to antimicrobial(s) for each of Compositions 33-34 were calculated and are reported in Table 26. For example, with reference to Table 26, the antimicrobial film formed from Composition 33 had a calculated weight percent of PVOH of 86%, and a calculated weight ratio of PVOH:PHMB:QUAT of 30:4:1. The columns headed “Wt % PVOH in the dry antimicrobial film” and “PVOH:Antimicrobial(s) wt ratio(s)” contain calculated values.

Compositions 33-34 were each tested wet and dry, each in replicates (designated in Table 26 as “A,” “B,” and “C” for the wet replicates and “D,” “E,” and “F,” for the dry replicates), for “fungal challenge,” at various timepoints, according to ASTM G21-96 (re-approved in 2002). Particularly, liquid film-forming compositions 33-34 were sprayed on a filter for 5 seconds or until the filter was saturated. For dry testing, three replicates of each composition were dried in a Biosafety hood until completely dry and used to apply spores. For wet testing, spore suspension was applied right after the composition was sprayed. The following organisms were used: Aspergillus niger (ATCC 9642), Penicillium funiculosum (ATCC 11797), Chaetomium globosum (ATCC 6205), Aureobasidium pullulans (ATCC 15233), and Trichoderma vixens (ATCC 9645). A piece of dry, sterile filter paper was also inoculated to serve as a positive control. The samples were incubated at 280° C. for up to four weeks. The progress of fungus growth was observed at various timepoints for four weeks, and is reported in Table 27. The fungal challenge rating scale, according to ASTM G21-96 is reproduced in Table 28.

TABLE 26

| | | | Wt % | Wt % | Wt % | | Wt % | |
|---|---|---|---|---|---|---|---|---|
| | | | PVOH | PHMB | QUAT | | PVOH in | |
| | | | in film- | in film- | in film- | | dry anti- | PVOH:Anti- |
| | Anti- | Wet/ | forming | forming | forming | Total % | microbial | microbial(s) |
| Sample | micr. | Dry | comp. | comp. | comp. | Solids | film | wt ratio(s) |
| Composition | PHMB + | Wet | 3 | 0.4 | 0.1 | 3.5 | 86 | 30:4:1 |
| 33-A | QUAT | | | | | | | |
| Composition | PHMB + | Wet | 3 | 0.4 | 0.1 | 3.5 | 86 | 30:4:1 |
| 33-B | QUAT | | | | | | | |
| Composition | PHMB + | Wet | 3 | 0.4 | 0.1 | 3.5 | 86 | 30:4:1 |
| 33-C | QUAT | | | | | | | |
| Composition | PHMB + | Dry | 3 | 0.4 | 0.1 | 3.5 | 86 | 30:4:1 |
| 33-D | QUAT | | | | | | | |
| Composition | PHMB + | Dry | 3 | 0.4 | 0.1 | 3.5 | 86 | 30:4:1 |
| 33-E | QUAT | | | | | | | |
| Composition | PHMB + | Dry | 3 | 0.4 | 0.1 | 3.5 | 86 | 30:4:1 |
| 33-F | QUAT | | | | | | | |
| Composition | PHMB + | Wet | 3 | 0.5 | 0.1 | 3.6 | 83 | 30:5:1 |
| 34-A | QUAT | | | | | | | |
| Composition | PHMB + | Wet | 3 | 0.5 | 0.1 | 3.6 | 83 | 30:5:1 |
| 34-B | QUAT | | | | | | | |
| Composition | PHMB + | Wet | 3 | 0.5 | 0.1 | 3.6 | 83 | 30:5:1 |
| 34-C | QUAT | | | | | | | |
| Composition | PHMB + | Dry | 3 | 0.5 | 0.1 | 3.6 | 83 | 30:5:1 |
| 34-D | QUAT | | | | | | | |
| Composition | PHMB + | Dry | 3 | 0.5 | 0.1 | 3.6 | 83 | 30:5:1 |
| 34-E | QUAT | | | | | | | |
| Composition | PHMB + | Dry | 3 | 0.5 | 0.1 | 3.6 | 83 | 30:5:1 |
| 34-F | QUAT | | | | | | | |

TABLE 27
Results of Fungal Challenge according to ASTM G21-96

| Sample | Day 0 | Day 7 | Day 14 | Day 21 | Day 28 |
|---|---|---|---|---|---|
| Control | 0 | 4 | 4 | 4 | 4 |
| Composition 33-A | 0 | 0 | 0 | 0 | 0 |
| Composition 33-B | 0 | 0 | 0 | 0 | 0 |
| Composition 33-C | 0 | 0 | 0 | 0 | 0 |
| Composition 33-D | 0 | 0 | 0 | 0 | 0 |
| Composition 33-E | 0 | 0 | 0 | 0 | 0 |
| Composition 33-F | 0 | 0 | 0 | 0 | 0 |
| Composition 34-A | 0 | 0 | 0 | 0 | 0 |
| Composition 34-B | 0 | 0 | 0 | 0 | 0 |
| Composition 34-C | 0 | 0 | 0 | 0 | 0 |
| Composition 34-D | 0 | 0 | 0 | 0 | 0 |
| Composition 34-E | 0 | 0 | 0 | 0 | 0 |
| Composition 34-F | 0 | 0 | 0 | 0 | 0 |

TABLE 28
Rating Scale for ASTM G21-96

| | |
|---|---|
| 0 | No Growth |
| 1 | 1-10% Coverage, Trace Growth |
| 2 | 10-30% Coverage, Light Growth |
| 3 | 30-60% Coverage, Moderate Growth |
| 4 | >60% Coverage, Heavy Growth |

The embodiments described above and illustrated in the figures are presented by way of example only and are not intended as a limitation upon the concepts and principles of the present invention. Various features and aspects of the invention are set forth in the following claims.

1.-44. (canceled)

45. A film-forming composition comprising:
a polyvinyl alcohol having a concentration of no greater than 10 weight percent of the film-forming composition;
a polyhexamethylene biguanide having a concentration of from 0.05 weight percent of the film-forming composition to 15 weight percent of the film-forming composition;
a quaternary ammonium compound having a concentration of from 0.001 weight percent of the film-forming composition to 10 weight percent of the film-forming composition; and
water or a water-based solvent in which the polyvinyl alcohol, the polyhexamethylene biguanide, and the quaternary ammonium compound are dissolved;
wherein the film-forming composition exhibits fast-acting biocidal activity, and wherein the film-forming composition forms a water-soluble antimicrobial film that exhibits residual biocidal activity.

46. The film-forming composition of claim 45, wherein the polyvinyl alcohol has an average molecular weight of no greater than 160,000 Daltons and a concentration of no greater than 1 weight percent.

47. The film-forming composition of claim 45, wherein the polyvinyl alcohol has an average molecular weight of no greater than 14,000 Daltons and a concentration of no greater than 12 weight percent.

48. The film-forming composition of claim 45, wherein the polyvinyl alcohol has an average molecular weight of no greater than 2,000 Daltons.

49. The film-forming composition of claim 45, wherein the polyhexamethylene biguanide has a concentration of less than 5 weight percent of the film-forming composition.

50. The film-forming composition of claim 45, wherein the quaternary ammonium compound has a concentration of from 0.1 to 5 weight percent of the film-forming composition.

51. The film-forming composition of claim 45, wherein the antimicrobial film exhibits microbial load reductions of at least 99% for gram positive bacteria and gram negative bacteria, when tested pursuant to at least one of ASTM E2180-01 and JIS Z 2801:2000.

52. The film-forming composition of claim 45, further comprising an indicator dye.

53. A wipe impregnated with the film-forming composition of claim 45.

54. A method of verifying the presence of an antimicrobial film, the method comprising:
applying the film-forming composition of claim 45 to a surface, wherein the film-forming composition further comprises an indicator dye that is adapted to change between a first state and a second state;
drying the film-forming composition to form a water-soluble biocidal antimicrobial film, the antimicrobial film exhibiting the first state of the indicator dye; and
triggering the indicator dye to change to the second state, such that the antimicrobial film exhibits the second state of the indicator dye to verify the presence of the antimicrobial film on the surface.

55. An antimicrobial film comprising:
a polyvinyl alcohol having a concentration of no greater than 98 weight percent of the antimicrobial film;
a polyhexamethylene biguanide having a concentration of from 1 weight percent of the antimicrobial film to 15 weight percent of the antimicrobial film; and
a quaternary ammonium compound having a concentration of from 1 weight percent of the antimicrobial film to 15 weight percent of the antimicrobial film;
the antimicrobial film being water-soluble and biocidal.

56. The antimicrobial film of claim 55, wherein no more than 50% of the polyvinyl alcohol has an average molecular weight of 14,000 Daltons.

57. The antimicrobial film of claim 55, wherein the antimicrobial film further comprises an indicator dye.
